(19) United States
(12) Patent Application Publication
(10) Pub. No.: US 2025/0265636 A1
(43) Pub. Date: Aug. 21, 2025

(54) SHOPPING SUPPORT SYSTEM PROVIDING ASSISTANCE SUMMONING AND ITEM LOCATION

(71) Applicant: Datalogic IP Tech S.R.L., Calderara di Reno (IT)

(72) Inventor: Chiara TADDIA, San Giovanni in Persiceto (IT)

(21) Appl. No.: 18/583,408

(22) Filed: Feb. 21, 2024

(51) Int. Cl. G06Q 30/0601

(52) U.S. Cl. CPC G06Q 30/0639; G06Q 30/0641

(57) ABSTRACT

A shopping support system includes: WAPs at a retail facility; a shopping device providing a UI enabling shopper input, and including a wireless network interface to both cooperate with the WAPs to triangulate the shopping device within the retail facility and transmit an indication of the input to at least one WAP; and a server including at least one processor to receive both an indication of the location of the shopping device and the indication of the input from the at least one WAP, and to determine whether a request for assistance in the input includes a first request for assistance in identifying the item based on the at least one characteristic, a second request for assistance associated with the item, or a third request for assistance in locating the item within the retail facility based on the contents of the input to the shopping device.

### BACKGROUND

### 1. Technical Field

The present disclosure relates to a system and method for locating and summoning assistance with items offered for rental and/or for sale within a retail facility.

### 2. Description of the Related Art

It is well known to provide shoppers with access to employees at a retail facility who have been familiarized with the locations and details of items offered therein. More specifically, it is well known to divide items into categories, to organize those items within a retail facility at least partially based on those categories, and to train employees at the retail facility to know at least the general organization of items therein by their categories. It is also well known to select particular ones of such employees to each become more specialized in their knowledge of one or more particular categories items within a retail facility, to train each of such employees to a greater degree concerning items that fall within the particular one or more categories about which he or she is meant to be more familiar, and to position each one of such employees within the retail facility to be relatively close to the items within the particular one or more categories about which he or she is meant to be more familiar. The intent is to enable a shopper to enter a portion of a retail facility that focuses on items of a particular category, and to be able to find an employee present therein who has been trained to a greater degree concerning those particular items. Unfortunately, due to such factors as employee turnover, shift changes, the considerably large size of at least a subset of retail facilities, and the resultant need for some employees to cover for other employees who may be absent due to illness, being on vacation or on break, or having changed employers, shoppers often find themselves unable to find an available employee who is familiar with an item of interest to that shopper, or even about the category of that item.

It is also well known to install, within a retail facility, various signs, maps, visual catalogs, etc. that are meant to direct shoppers to portions of the retail facility at which particular categories of items are positioned for being viewed and/or selected by shoppers for purchase, rental, etc. Unfortunately, the directing of shoppers to locations at which categories of items may be found requires shoppers to discern what category a particular item of interest falls within. This is necessarily based on a presumption that the shoppers will categorize items in a manner similar to how items have been categorized within the retail facility. Such categorization is often based on the functions and/or features of each object, and it is not uncommon for the functions and/or features of an object to cause differences to arise between how it may be categorized within a retail facility versus how it may be categorized by at least some shoppers.

As a result, it is not uncommon for a shopper to become frustrated in their efforts to select and retrieve an item for purchase or rental from a retail facility. Although there may be various signs, maps, etc. posted at various locations therein, the guidance provided is usually relatively vague indications of where various categories of items are located. After determining what category a particular item of interest falls within, the shopper is usually required to proceed to a portion of the retail facility at which items of that category are located, and then search within that portion of the retail facility for the item of interest. If the shopper mistakenly considered the item of interest to be in a different category from the one in which it was categorized within the retail facility, then the shopper must reconsider the categorization of the item of interest, and proceed to a different portion of the retail facility to try to find it.

Even if the shopper is able to locate the item of interest relatively quickly within the retail facility, viewing the item and/or comparing it to other similar items in the same portion of the retail facility may elicit questions about the item of interest, the degree to which it is suitable for the shopper's purposes in comparison to the other similar items, and so on. To address such questions, the shopper may desire to talk to an employee of the retail facility about the item of interest. However, as previously discussed, finding an employee who is available (e.g., not already engaged in assisting another shopper), and who is familiar with the item of interest and/or the other similar items may be a challenge. The shopper may be forced to walk around the interior of the retail facility to attempt to find such an employee, only to have to be redirected among employees or to be given answers to their questions by a less than knowledgeable employee. A further frustration may be that the shopper either forgets to ask a particular question after searching about for an employee, develops another question to ask after returning to the location of the item of interest after talking to an employee, and/or forgets where they found the item of interest such that they must search for it, again.

A solution is needed to improve the efficiency with which a shopper is able to locate an item of interest within a retail facility (especially within so-called “big box” retail facilities). A solution is also needed to improve the efficiency with which a shopper is able to locate or contact a knowledgeable employ to assist the shopper with information about an item of interest, and/or to assist the shopper in identifying the item of interest.

### SUMMARY

Technologies are described for more efficiently identifying and/or locating items within a retail facility, and/or for more efficiently locating and/or contacting personnel able to assist in identifying and/or locating items within a retail facility.

A shopping support system includes a set of wireless access points (WAPs) installed at a retail facility. A shopping support system also includes a shopping device including: a scanning engine to capture an image of an indicia that encodes an identifier of an item of interest to a shopper; a display to provide a user interface (UI) that enables the shopper to provide input indicative of at least one of at least one characteristic of the item, the identifier of the item, and a request for assistance; and a wireless network interface to cooperate with the set of WAPs to triangulate a current location of the shopping device within the retail facility, and to transmit, to at least one WAP of the set of WAPs, an indication of the input to the shopping device. A shopping support system further includes a server coupled to the set of WAPs, the server including at least one processor configured to: receive, from the at least one WAP, an indication of the current location of the shopping device, and the indication of the input provided to the shopping device; and in response to the input to the shopping device including the request for assistance, and based on other contents of the input to the shopping device, determine whether the request for assistance includes a first request for assistance in identifying the item based on the at least one characteristic, a second request for assistance associated with the item, or a third request for assistance in locating the item within the retail facility.

A method includes receiving, by at least one processor at a server of a shopping support system, and from a shopping device through at least one wireless access point (WAP) of a set of WAPs installed at a retail facility, an indication of input to the shopping device through a user interface (UI) that enables a shopper to provide input indicative of at least one of: at least one characteristic of the item; the identifier of the item; and a request for assistance. The method also includes receiving, by the at least one processor, and from the at least one WAP, an indication of a current location of the shopping device within the retail facility. The method further includes, in response to the input to the shopping device including the request for assistance, and based on other contents of the input to the shopping device, determining, by the at least one processor, whether the request for assistance includes: a first request for assistance in identifying the item based on the at least one characteristic; a second request for assistance associated with the item; or a third request for assistance in locating the item within the retail facility.

A shopping device of a shopping support system includes: a scanning engine configured to capture an image of an indicia that encodes an identifier of an item of interest to a shopper; and a wireless network interface configured to cooperate with the set of WAPs to triangulate a current location of the shopping device within the retail facility, and to transmit, to at least one WAP of the set of WAPs, an indication of the input to the shopping device. The shopping device also includes at least one processor coupled to the scanning engine and the wireless network interface, and configured to: provide a user interface (UI) that enables the shopper to provide input indicative of at least one of at least one characteristic of the item, the identifier of the item, and a request for assistance; operate the wireless network interface to cooperate with the set of WAPs to triangulate a current location of the shopping device within the retail facility; operate the wireless network interface to transmit, to a support server via at least one WAP of the set of WAPs, an indication of the input to the shopping device; receive a transmission from the support server in response to the indication of the input to the shopping device, wherein, based on other contents of the input to the shopping device, the support server is configured to determine whether the request for assistance includes a first request for assistance in identifying the item based on the at least one characteristic, a second request for assistance associated with the item, or a third request for assistance in locating the item within the retail facility; in response to the received transmission including an indication that assistance from an employee will be provided in response to a determination by the support server that the request transmitted to the support server includes either the first request or the second request, present the indication that the assistance from an employee will be provided to the shopper via the UI; and in response to the received transmission including an indication of guidance to a shopper-accessible location associated with the item transmitted to the shopping device in response to a determination by the support server that the request transmitted to the support server includes the third request, present the guidance to the shopper via the UI, and cooperate with the set of WAPs to recurringly determine a current location of the shopping device within the retail facility.

### BRIEF DESCRIPTION OF THE DRAWINGS

FIG. 1 is a block diagram of an embodiment of a shopping support system.

FIGS. 2A, 2B and 2C, together, provide a combination of perspective and block diagrams of embodiments of a shopping device of the shopping support system of FIG. 1.

FIGS. 3A and 3B, together, provide a combination of perspective and block diagrams of embodiments of a service device of the shopping support system of FIG. 1.

FIGS. 4A, 4B, 4C, 4D and 4E, together, provide a set of block diagrams of differing aspects of a support server of the shopping support system of FIG. 1.

FIGS. 5A, 5B, 5C, 5D, 5E and 5F, together, provide a flowchart of aspects of an embodiment of operation of the shopping support system of FIG. 1.

### DETAILED DESCRIPTION

In the following detailed description, reference is made to the accompanying drawings that form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

Disclosed herein is a shopping support system configured to assist a shopper in more speedily identifying and/or locating items within a retail facility. Also disclosed herein is a shopping support system configured to assist a shopper in more speedily locating and/or contacting personnel able to assist in identifying and/or locating items within a retail facility.

A shopping support system includes a set of wireless access points (WAPs) installed at a retail facility. A shopping support system also includes a shopping device including: a scanning engine to capture an image of an indicia that encodes an identifier of an item of interest to a shopper; a display to provide a user interface (UI) that enables the shopper to provide input indicative of at least one of at least one characteristic of the item, the identifier of the item, and a request for assistance; and a wireless network interface to cooperate with the set of WAPs to triangulate a current location of the shopping device within the retail facility, and to transmit, to at least one WAP of the set of WAPs, an indication of the input to the shopping device. A shopping support system further includes a server coupled to the set of WAPs, the server including at least one processor configured to: receive, from the at least one WAP, an indication of the current location of the shopping device, and the indication of the input provided to the shopping device; and in response to the input to the shopping device including the request for assistance, and based on other contents of the input to the shopping device, determine whether the request for assistance includes a first request for assistance in identifying the item based on the at least one characteristic, a second request for assistance associated with the item, or a third request for assistance in locating the item within the retail facility.

A method includes receiving, by at least one processor at a server of a shopping support system, and from a shopping device through at least one wireless access point (WAP) of a set of WAPs installed at a retail facility, an indication of input to the shopping device through a user interface (UI) that enables a shopper to provide input indicative of at least one of: at least one characteristic of the item; the identifier of the item; and a request for assistance. The method also includes receiving, by the at least one processor, and from the at least one WAP, an indication of a current location of the shopping device within the retail facility. The method further includes, in response to the input to the shopping device including the request for assistance, and based on other contents of the input to the shopping device, determining, by the at least one processor, whether the request for assistance includes: a first request for assistance in identifying the item based on the at least one characteristic; a second request for assistance associated with the item; or a third request for assistance in locating the item within the retail facility.

A shopping device of a shopping support system includes: a scanning engine configured to capture an image of an indicia that encodes an identifier of an item of interest to a shopper; and a wireless network interface configured to cooperate with the set of WAPs to triangulate a current location of the shopping device within the retail facility, and to transmit, to at least one WAP of the set of WAPs, an indication of the input to the shopping device. The shopping device also includes at least one processor coupled to the scanning engine and the wireless network interface, and configured to: provide a user interface (UI) that enables the shopper to provide input indicative of at least one of at least one characteristic of the item, the identifier of the item, and a request for assistance; operate the wireless network interface to cooperate with the set of WAPs to triangulate a current location of the shopping device within the retail facility; operate the wireless network interface to transmit, to a support server via at least one WAP of the set of WAPs, an indication of the input to the shopping device; receive a transmission from the support server in response to the indication of the input to the shopping device, wherein, based on other contents of the input to the shopping device, the support server is configured to determine whether the request for assistance includes a first request for assistance in identifying the item based on the at least one characteristic, a second request for assistance associated with the item, or a third request for assistance in locating the item within the retail facility; in response to the received transmission including an indication that assistance from an employee will be provided in response to a determination by the support server that the request transmitted to the support server includes either the first request or the second request, present the indication that the assistance from an employee will be provided to the shopper via the UI; and in response to the received transmission including an indication of guidance to a shopper-accessible location associated with the item transmitted to the shopping device in response to a determination by the support server that the request transmitted to the support server includes the third request, present the guidance to the shopper via the UI, and cooperate with the set of WAPs to recurringly determine a current location of the shopping device within the retail facility.

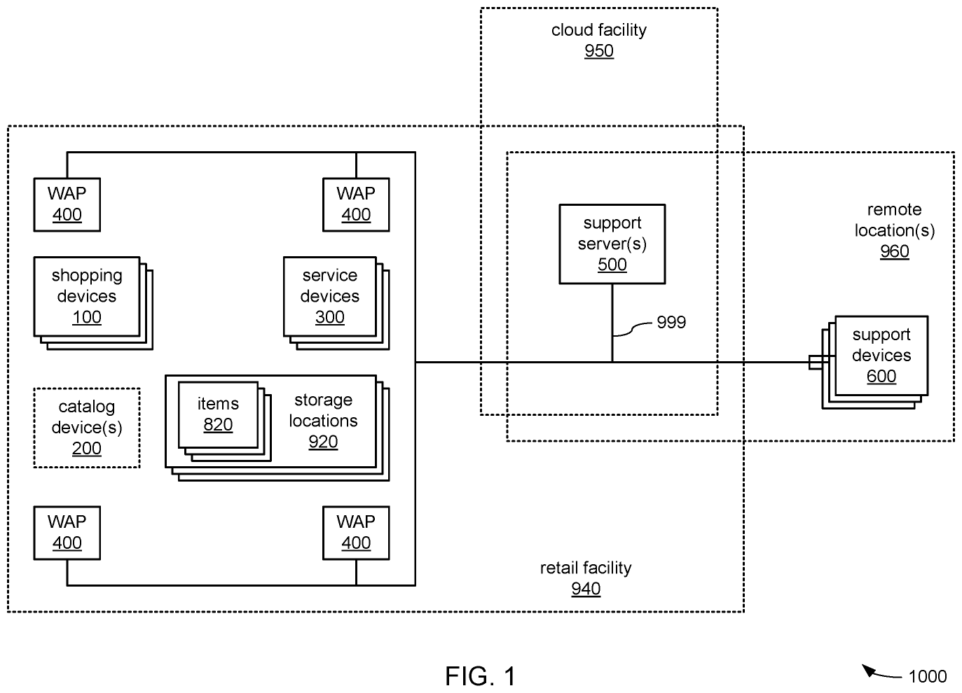

FIG. 1 depicts an example embodiment of a shopping support system 1000 to support shoppers at a retail facility 940. As depicted, various devices of the automated shopping support system 1000 may be spread across multiple locations, including at the retail facility 940, at a cloud facility 950 that is remote from the retail facility 940, and/or at remote location(s) 960 that are also remote from the retail facility 940. More specifically, at the depicted retail facility 940, the shopping support system 1000 may include multiple shopping devices 100, one or more catalog devices 200, multiple service devices 300, and/or multiple wireless access points (WAPs) 400. The shopping support system 1000 may also include one or more support servers 500 at the retail facility 940, at a cloud facility 950, and/or at one or more remote locations 960. Further, spread across the one or more remote locations 960, the shopping support system 1000 may further include multiple support devices 600.

Still further, these devices 100, 200, 300, 400, 500 and/or 600 may be interconnected by a network 999. As depicted, at least a subset of these devices may communicate via wireless transmissions such that at least a portion of the network 999 may be based on one or more forms of wireless signaling technology. As also depicted, at least a subset of these devices may be spread across multiple geographic locations such that at least a portion of the network 999 extend through portions of the Internet.

The retail facility 940 may be any of a variety of types of building or other structure at which a wide variety of items 820 may be offered for rental and/or for purchase by shoppers visiting the retail facility 940. As depicted, the interior of the retail facility 940 may define numerous storage locations 920 at which the items 820 may be positioned by employees of the retail facility 940 for storage, for being displayed to the shoppers, and/or from which shoppers may pick up a selected one of the items 820 for rental or purchase. More specifically, at least some of such storage locations 920 may be defined by shelving and/or other pieces of furniture (not specifically shown) that provide locations at which various ones of the items 820 may be stored in a manner that is meant to be accessible to shoppers for viewing and/or for physically picking up as part of shopping. Alternatively or additionally, at least some of such storage locations 920 may be defined by shelving and/or other pieces of furniture that provide locations at which others of the items 820 may be stored in a manner that is meant to be accessible to employees, but is not meant to be accessible to shoppers.

As part of installing the shopping support system 1000, the multiple ones of the WAPs 400 may be installed at a variety of stationary positions throughout the interior of the retail facility 940. This installation of the WAPs 400 may be with sufficient density within the retail facility 940 as to provide a wireless portion of the network 999 that thoroughly covers the interior of the retail facility 940 such that no shopping device 100 or service device 300 is able to be carried about therein without remaining in connection with the network 999. Alternatively or additionally, this installation of the WAPs 400 may be with sufficient density within the retail facility 940 as to enable the location of each shopping device 100 and service device 300 to be triangulated therein.

As will be explained in greater detail, the service devices 300 may be portable electronic devices that are provided to the employees of the retail facility 940. It may be that each of the service devices 300 is assigned to a particular employee for at least a period of time during which that particular employee is present at the retail facility 940 and/or is actively using it. More specifically, and as will be familiar to those skilled in the art, it may be that each employee at the retail facility 940 is required to check out one of the service devices 300 as part of using it. In this way, while an employee is present at the retail facility 940, and is using a particular one of the service devices 300, that particular one the service devices 300 is caused to be associated with that employee, and its location within the retail facility 940 may be deemed to be the location of that employee therein.

As will similarly be explained in greater detail, the shopping devices 100 may be portable electronic devices that are provided to the shoppers visiting the retail facility 940. It may be that each of the shopping devices 100 is provided to a shopper while at the retail facility 940 to assist them in shopping thereat. More specifically, it may be that each shopper is at least afforded an opportunity to check out one of the shopping devices 100 as part of using it. In this way, while a shopper is present at the retail facility 940, and is using a particular one of the shopping devices 100, that particular one of the shopping devices 100 is caused to be associated with that shopper, and its location within the retail facility 940 may be deemed to be the location of that shopper therein.

Each of the one or more catalog devices 200 (if any are present within the retail facility 940) may be an electronic device that is installed at a location within the retail facility 940 that is meant to make it accessible for use by shoppers, such as in the vicinity of an entrance doorway of the retail facility 940. Each such catalog device 200 may provide visual access to an electronic version of a catalog of the items 820 offered at the retail facility 940, and such a catalog may be made searchable in various ways to enable a shopper to search for and/or identify an item 820 that is of interest to them. As will be explained in greater detail, each entry therein for one of the items 820 may include an indicia (e.g., a bar code, a QR code, a particular portion of human-readable text, etc.) that may be scanned by a shopping device 100 to transfer an indication thereto of the identity of an item 820 of interest. However, it should be noted that, as an alternative to such one or more catalog devices 200 being positioned within the retail facility 940, it may be that paper catalogs may be provided that incorporate such entries in printed form for items 820 offered at the retail facility 940.

Each of the support devices 600 (if any are included within the shopping support system 1000) may be an electronic device that is provided to another employee located at a remote location 960, instead of being located within the retail facility 940. It may be that each of the support devices 600 is assigned to a particular remotely located employee. In this way, each support device 600 is caused to become associated with a particular remotely located employee.

As previously discussed, the one or more support servers 500 may be located at the retail facility 940, at one or more of the remote locations 960, and/or at a cloud facility 950 that is also remotely located from the retail facility 940. As will be explained in greater detail, the support server(s) 500 may store information concerning the retail facility 940, the items 820 offered thereat, the employees thereat, remotely located employees, etc. As will also be explained in greater detail, the support server(s) 500 may cooperate with various ones of the other devices 100, 200, 300, 400 and/or 600 through the network 999 to assist shoppers at the retail facility 940 with identifying, locating and/or selecting items 820 at the retail facility for rental and/or purchase.

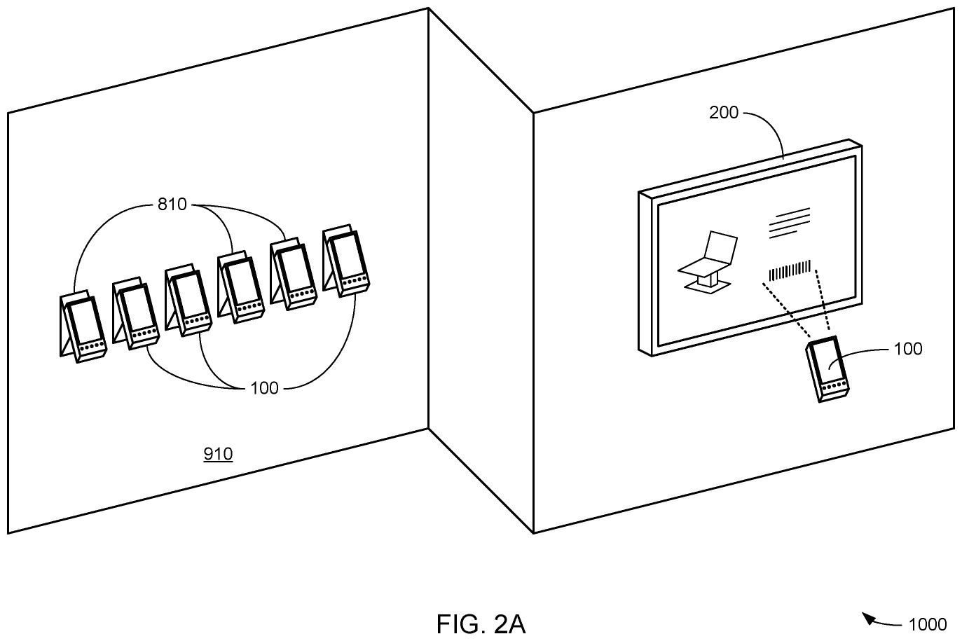

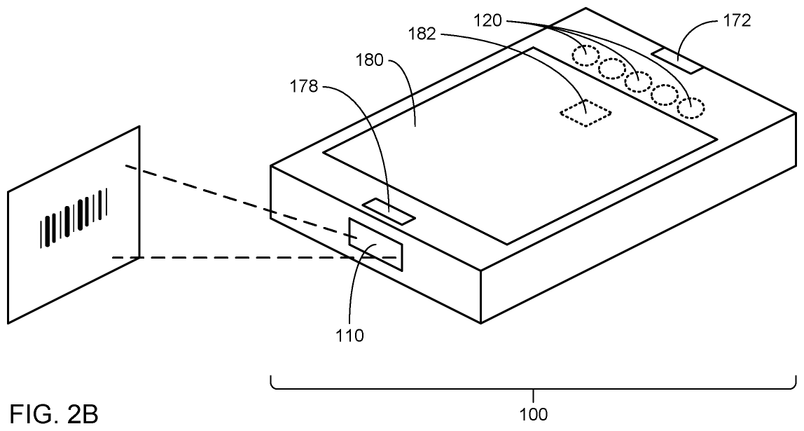

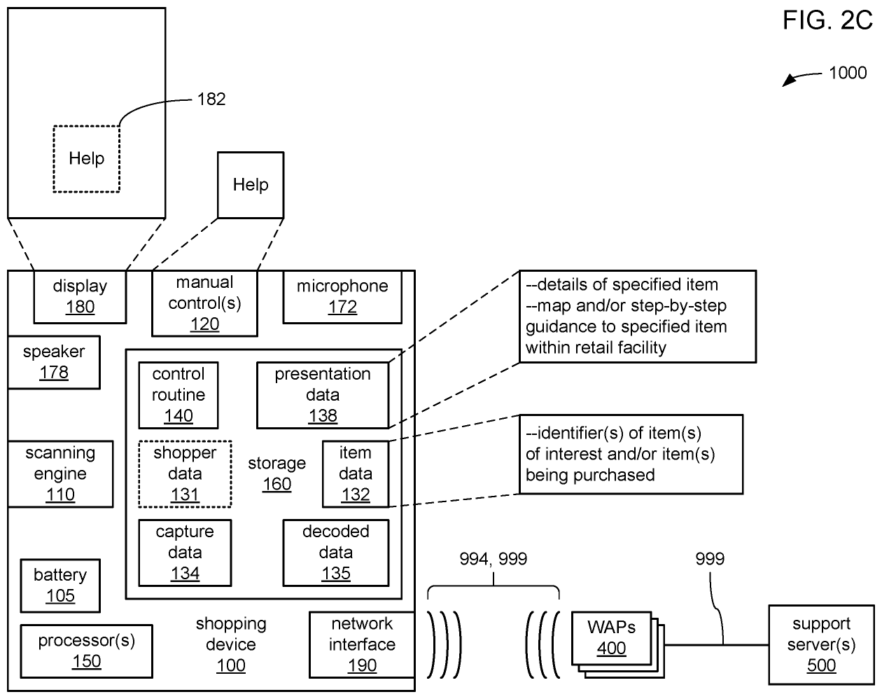

FIGS. 2A, 2B and 2C, together, depict aspects of the shopping devices 100 of the shopping support system 1000 in greater detail.

Turning to FIG. 2A, it may be that the retail facility 940 includes a distinct device checkout area 910 to provide each shopper with a shopping device 100. Such a device checkout area 910 may be positioned relatively close to an entrance of the retail facility 940 through which shoppers may be expected to enter. More specifically, at such a location, there may be multiple device checkout stations 810 from which a shopper may checkout a shopping device 100. In some embodiments, it may be that each of the checkout stations 810 also serves as a charging station.

In various embodiments, the procedure that a shopper may follow for checking out a shopping device 100 may entail the use of a customer loyalty card that may be associated with an account that a shopper may have with the retail facility 940. Such a customer loyalty card may be equipped with a barcode, a magnetic stripe, a radio-frequency identification device (RFID) tag supporting near-field communications (NFC), or any of a variety of other mechanisms by which a shopper associated with such a card is able to be identified to obtain a shopping device 100. Alternatively or additionally, the checking out procedure followed by a shopper to check out a shopping device 100 may entail the shopper providing a fingerprint, password, or other input that uniquely identifies the shopper.

In various embodiments, the shopping devices 100 may serve to simplify the various tasks of a shopper within a retail facility 940. For example, a shopping device 100 may enable a shopper to add one or more items 820 to a virtual shopping cart without the need to physically push around a physical shopping cart, by scanning the indica associated to the items by means of the scanning engine 110 while inserting the items inside the physical shopping cart. After using a shopping device 100 to fill the virtual shopping cart with one or more desired items 820, a shopper may simply bring that shopping device 100 to a checkout location within the retail facility 940, where the shopper then pays for those one or more desired items 820.

Turning to FIG. 2B, in addition to FIG. 2A, regardless of the exact manner in which a shopper is provided with and/or uses a shopping device 100, each shopping device 100 may incorporate a scanning engine 110 that enables scanning indicia (e.g., human-readable text, barcodes, QR codes, watermarks, etc.) that may encode information, such as an identifier of an item 820. It may be that the scanning engine 110 is able to be used by a shopper to scan an indicia associated with an item 820 to add it to a virtual shopping cart. Such an indicia may be present on a surface of an object (e.g., by being printed thereon), such as on a surface of an item 820, on a surface of packaging of an item 820, on a label at a location within a retail facility 940 at which an item 820 is displayed, on a paper flier brought to the shopping facility 940 by a shopper, or on a page of a printed paper catalog. Alternatively, such an indicia may also be visually presented by a display device, such as a catalog device 200 (if any are present). Again, as depicted and as previously discussed, an embodiment of a catalog device 200 may be positioned adjacent such a device checkout area 910 to, in cooperation with a shopping device 100, assist a shopper in identifying and/or locating an item 820 of interest.

Again, such a catalog device 200 (if any are present) may provide a shopper with visual access to a database of the items 820 that are offered at the retail facility 940. The catalog device 200 may provide a user interface (UI) that enables a shopper to search for an item 820 of interest in various ways (e.g., entry of a textual description, entry of a universal product code (UPC), visually with images, spoken description, etc.). Upon identifying an item 820 of interest, the catalog device 200 may display an indicia (e.g., the depicted example barcode) that the shopping device 100 provided to the shopper may be capable of scanning. In this way, input identifying the item 820 of interest may be provided to the shopping device 100.

However, as another alternative to the provision of such a catalog device 200 and/or a printed catalog, or in addition to thereto, it may be that each one of the shopping devices 100 is, itself, capable of providing catalog search functionality to a shopper to assist in identifying an item 820 of interest.

More specifically, each shopping device 100 may incorporate a display 180 and various manual controls 120 (e.g., buttons, levers, knobs, slide switches, joysticks, roller ball, etc.) that, together, provide at least part of a UI by which a shopper may use the shopping device 100 to search for an item 820 of interest. As alternative to, or in addition to, the manual controls 120, it may be that the display 180 is a touch-sensitive display, and that one or more virtual manual controls 182 (e.g., virtual buttons, virtual sliders, virtual dials, etc.) are visually presented on the display 180 as part of such a UI. Through such manual controls 120 and/or such virtual manual controls 182, a shopper may be able to enter text, a UPC, and/or another form of identifier of an item 820 of interest. The display 180 may then be used to visually present a view of the item 820 of interest to allow the shopper confirm that the correct item 820 is being identified. The shopper may then operate a manual control 120 or virtual manual control 182 to confirm that the correct item 820 has been found.

As an alternative to, or in addition to, such a UI employing a scanning engine 110, manual controls 120 and/or virtual manual controls 182 to enable the provision of such input, each shopping device 100 may incorporate a microphone 172 and a speaker 178 that, together, provide at least part of a voice-based UI by which a shopper may use voice communications with the shopping device 100 to search for an item 820 of interest. More specifically, instead of using the scanning engine 110, or using controls 120 and/or 182 to provide input identifying an item 820 of interest, a shopper may use their voice to provide such input.

Regardless of the exact manner in which a shopper provides input to a shopping device 100 identifying and/or confirming the identification of an item 820 of interest, upon doing so, a shopper may then provide input to the shopping device 100 indicative of a request to be guided to where the item 820 of interest may be found. The shopping device 100 may then cooperate with a combination of devices 400 and/or 500 to so guide the shopper to such a storage location 920 at which the item 820 of interest may be stored in a manner that is meant to be accessible to shoppers. In so doing, it may be that the display 180 is operated to provide visual guidance (e.g., a visual display of arrows pointing toward such a storage location 920), and/or it may be that the speaker 178 (if present) is operated to provide audible guidance (e.g., a synthesized voice providing guidance to such a storage location 920).

Alternatively or additionally, upon providing input to a shopping device 100 that identifies or confirms the identification of an item 820 of interest, a shopper may then provide input to the shopping device 100 indicative of a request to summon assistance from an employee concerning the item 820 of interest. As will be explained in greater detail, such a summoning of employee assistance may result in an employee of the retail facility being similarly guided to the current location of the shopper by a service device 300 associated with that employee, and in cooperation with a combination of devices 400 and/or 500. Alternatively, and as will also be explained in greater detail, such a summoning of employee assistance may result in the shopper being put in contact with an employee (e.g., audio and/or visual communications) through the shopping device 100 and a service device 300 of that employee.

As still another alternative, it may be that a shopper does not know which item 820 is likely to be of interest to them, and therefore, does not provide input to the shopping device 100 that identifies an item 820 of interest. Instead, such a shopper may provide input to the shopping device 100 that is indicative of a request to summon assistance from an employee to aid the shopper in identifying an item 820 of interest that may fill a need for the shopper. Again, this may result in an employee being guided to the current location of the shopper, or may result in the shopper being put in contact with an employee.

Turning to FIG. 2C, in addition to FIG. 2B, each of the shopping devices 100 may include a battery 105, the scanning engine 110, one or more manual controls 120, one or more processors 150, a storage 160, the microphone 172, the speaker 178, the display 180, and/or a network interface 190. These components 105, 110, 120, 160, 172, 178, 180 and/or 190 may each be communicatively coupled to the one or more processors 150 to exchange data therewith through the exchange of electrical, optical, magnetic and/or other signals through one or more buses and/or other form of interconnect.

As previously discussed, and as will be discussed in more detail, various ones of the scanning engine 110, the manual control(s) 120, the microphone 172 (if present), the speaker 178 (if present), the display 180, and/or any virtual manual controls 182 that may be visually presented on the display 180 may be used to provide a UI to a shopper associated with the shopping device 100. Through such a UI, input may be received from a shopper that identifies an item 820 of interest, that conveys a request for guidance to a location of that item 820, and/or that conveys a request summoning assistance from an employee. Also through such a UI, such requested guidance to a location of the item 820 of interest may be provided, and/or such requested communications with an employee providing such assistance may be provided. Alternatively, where a shopper does not yet know what item 820 would address their needs, such a UI may be used to receive input from the shopper summoning assistance from an employee to aid the shopper in identifying an appropriate item 820.

The network interface 190 may support the use of a variety of wireless networking technologies and/or industry standards to instantiate and/or maintain a set of wireless links 994 of the network 999 with at least some of the multiple WAPs 400 installed at various locations within the retail facility 940. As will be explained in greater detail, various pieces of data may be exchanged with other devices 300, 400, 500 and/or 600 through one or more of such wireless links 994. As will also be explained in greater detail, a combination of information concerning the locations of each of the multiple WAPs 400, and the signal strength of each wireless link 994 with one of the multiple WAPs 400 may be used to recurringly determine the current location of the shopping device 100 within the retail facility 940. Such recurring determinations of the current location of the shopping device 100 may be used in guiding the shopper using the shopping device 100 to a location of an item 820 of interest, and/or may be used in guiding an employee of the retail facility 940 to a location of that shopper.

The storage 160 may store shopper data 131 indicative of various details specific to the particular the shopper currently using the particular shopping device 100. Such details could include the name of the shopper for use in presenting a greeting to the shopper on the display 180. Such details could also include current offers of savings to the shopper that may be personalized to the shopper. Such details could further include various messages that are pertinent to the shopper and/or to the account that the shopper has with the retail facility 940. The storage 160 may also store item data 132 indicative of items 820 that the shopper has shown some degree of interest in at earlier times, and/or items 820 that are currently of interest to the shopper. Such indications of past and/or present items 820 of interest may be used to provide images of such items 820 on the display 180 in a manner that may make it easier for the shopper to indicate a current item 820 of interest by simply selecting it.

The storage 160 may store one or both of capture data 134 and decoded data 135. The capture data 134 may be defined within the storage 160 as a buffer location in which data captured by the scanning engine 110, the manual controls 120, the microphone 172, and/or the example virtual manual control 182 depicted as being visually presented on the display 180. As such buffered data within the capture data 134 is processed to interpret its meaning (either by the processor(s) 150 of the shopping device 100 or by processor(s) of another device), indications of what has been decoded via such processing may be stored as part of the decoded data 135. For example, indications of touches of the display 180 that may be consistent with operation of any virtual manual controls 182 presented thereon may be buffered within the capture data 134, before being interpreted to identify what virtual manual control 182 may have been operated, whereupon indications of such operation of such virtual manual controls 182 may be stored within the decoded data 135. Also by way of example, images captured by the scanning engine 110 of what may be indicia for being decoded may be buffered within the capture data 134, before being processed to identify and decode any such indicia therein, whereupon indications of what may have been decoded therefrom may be stored within the decoded data 135. By way of a further example, audio captured by the microphone 172 of what may be a shopper's voice input may be buffered within the capture data 134, before being processed to identify and decode any speech sounds that may be present, whereupon indications of words spoken that identify an item 820 of interest, and/or that convey a request by the shopper to locate the item 820 of interest or to summon employee assistance with the item 820 of interest may be stored within the decoded data 135.

The storage 160 may store presentation data 138, which may be defined within the storage 160 as a buffer of images presented on the display 180. Such buffered images may include, and is not limited to, images of items 820 of interest and/or accompanying information, images of virtual manual controls 182, images of guides to an item 820 of interest that may be presented on the display 180 (e.g., arrows and/or indications of distance), etc.

The storage 160 may store a control routine 140 that may incorporate a sequence of instructions operative on the one or more processors 150 to cause the processor(s) 150 to perform various functions in support of a shopper shopping for an item 820 of interest within the retail facility 940. Among those various functions may be to interact with various ones of the other components 105, 110, 120, 160, 172, 178, 180 and/or 190 to perform various operations. By way of example, the processor(s) 150 may operate various ones of the components 110, 120, 172, 178 and/or 180 to provide the aforedescribed UI. Also by way of example, the processor(s) 150 may operate at least the network interface 190 to exchange data with one or more other devices 300, 500 and/or 600 through one or more of the wireless links 994 of the network 999 formed with one or more of the WAPs 400. Further by way of example, the processor(s) 150 may operate at least the network interface 190 to cooperate with the at least some of the WAPs 400 and/or the support server(s) 500 to derive the current location of the shopping device 100 within the retail facility 940.

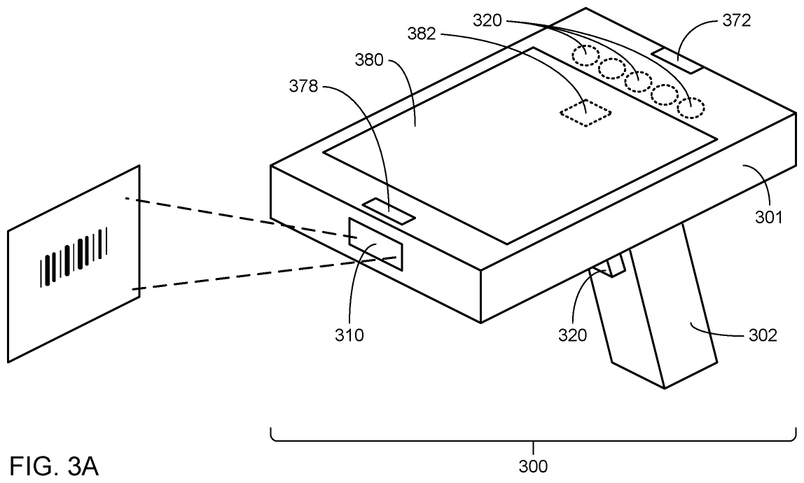

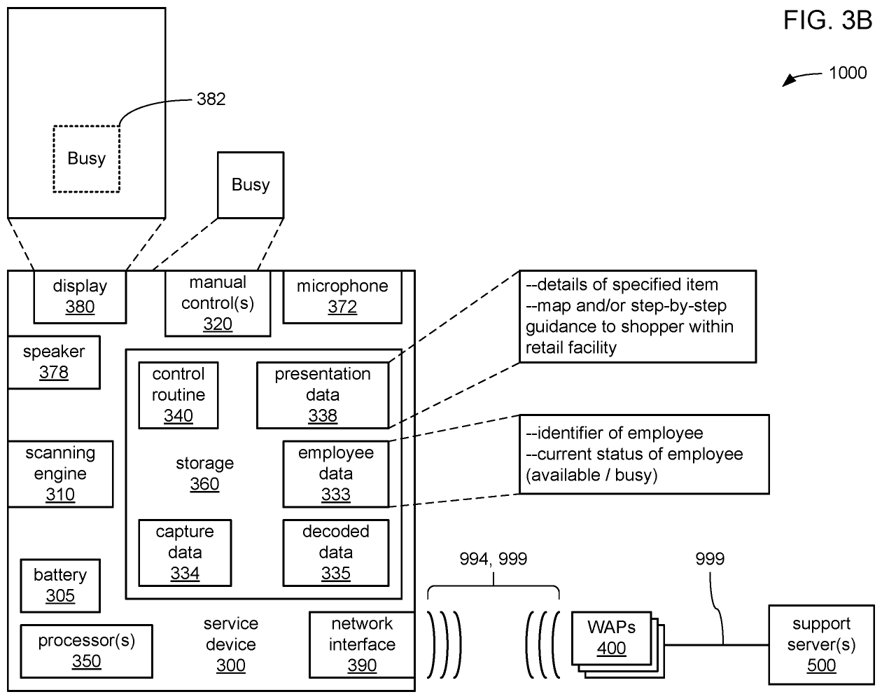

FIGS. 3A and 3B, together, depict aspects of the service devices 300 of the shopping support system 1000 in greater detail. Unlike the shopping devices 100 that are meant to be provided to shoppers, the service devices 300 are meant to be provided to employees of the retail facility 940. As will be familiar to those skilled in the art, such devices may be provided to such employees to support such employee tasks as maintaining stocks of items 820 in places where they are meant to be stored, occasionally changing those storage locations 920 at times when the retail facility is reconfigured in anticipation of upcoming holidays and/or various retail-related events, and tracking changes in inventory of the items 820 offered thereat.

Turning to FIG. 3A, as depicted, in some embodiments, and unlike the casing of the shopping devices 100, the casing of the service devices 300 may have a more “gun-like” physical configuration insofar as the casing of the service devices 300 may include both a generally flat upper portion 301 that may greatly resemble a typical relatively flat one-piece smart phone, and a lower grip-like portion 302 that may be coupled to the upper portion 301 in a manner that imparts the overall “gun-like” physical appearance, including the placement of a manual control 320 at a location very much like that of the trigger of a gun. As will be familiar to those skilled in the art, such an overall physical configuration may be deemed advantageous as it may be expected that employees of the retail facility may be expected to make frequent use of the scanning engine 310 that may be incorporated into each of the services devices 300 at a location very much reminiscent of the open end of a barrel of a gun. Stated differently, such a physical configuration lends itself to a quick and easily performed “point and shoot” manner of using the scanning engine 310 to scan indicia that may be carried on an external surface of an item 820 (or on an external surface of a package containing an item 820), as well as indicia that may be carried on shelving and/or other furnishings within the retail facility 940 that define the storage locations 920 at which items 820 may be stored. Thus, such a physical configuration may improve the efficiency with which employees of the retail facility do their work as they use the scanning of indicia as an integral part in recording and maintaining information concerning what quantities of items 820 are within the retail facility 940, and at what storage locations 920.

However, in other embodiments, it may be that the casings are entirely identical between the shopping devices 100 and the service devices 300. In such embodiments, it may be that the hardware of the shopping devices 100 and the service devices 300 are identical, and that these devices 100 and 300 differ only in what executable routines and/or what data are stored within each. Indeed, in such embodiments, it may be possible to switch a portable electronic device between functioning as a shopping device 100 and serving as service device 300.

Turning to FIG. 3B, in addition to FIG. 3A, each of the service devices 300 may include a battery 305, the scanning engine 310, one or more manual controls 320, one or more processors 350, a storage 360, a microphone 372, a speaker 378, a display 380, and/or a network interface 390. These components 305, 310, 320, 360, 372, 378, 380 and/or 390 may each be communicatively coupled to the one or more processors 350 to exchange data therewith through the exchange of electrical, optical, magnetic and/or other signals through one or more buses and/or other form of interconnect.

Various ones of the scanning engine 310, the manual control(s) 320, the microphone 372 (if present), the speaker 378 (if present), the display 380, and/or any virtual manual controls 382 that may be visually presented on the display 380 may be used to provide a UI to an employee associated with the service device 300. Through such a UI, input may be received from an employee that identifies item(s) 820 that are being moved about, stored and/or inventoried by that employee.

Also through such a UI, and as will be discussed in greater detail, an employee may receive and/or respond to a request to assist a shopper, may indicate a degree of availability and/or lack thereof for responding to such requests, may be guided to the current location of a shopper having made such a request, and/or may remotely communicate with a shopper having made such a request. More specifically, the display 380 and/or the speaker 378 (if present) may be used to provide an indication to an employee that they are being requested to provide assistance to a shopper. Correspondingly, the manual control(s) 320 and/or any virtual manual controls 382 that are visually presented on the display 380 may be used by that employee to provide input that service device 300 indicative of their degree of availability (or lack thereof), and/or indicative of their response to such a request for assistance. Further, the display 380 and/or the speaker 378 may be used to visually and/or audibly guide that employee to the current location of such a shopper. Alternatively or additionally, the combination of the microphone 372 and speaker 378 (if present) may be used by that employee to engage in remotely assisting such a shopper via voice communications.

The network interface 390 may support the use of a variety of wireless networking technologies and/or industry standards to instantiate and/or maintain a set of wireless links 994 of the network 999 with at least some of the multiple WAPs 400 installed at various locations within the retail facility 940. As will be explained in greater detail, various pieces of data may be exchanged with other devices 100, 400, 500 and/or 600 through one or more of such wireless links 994. As will also be explained in greater detail, a combination of information concerning the locations of each of the multiple WAPs 400, and the signal strength of each wireless link 994 with one of the multiple WAPs 400 may be used to recurringly determine the current location of the service device 300 within the retail facility 940. Such recurring determinations of the current location of the service device 300 may be used in guiding the employee using the service device 300 to the current location of a shopper requesting assistance.

The storage 360 may store employee data 333 indicative of various details specific to the particular the employee currently using the particular service device 300. Such details could include the name of the employee for use in presenting an identifier of which employee is currently associated with the particular service device 300 on the display 380. Such details could also include a local copy of a current version of scheduled work hours and/or locations for the employee, including indications of planned breaks, meetings and/or other portions of time and/or dates during which the employee is or is not available to respond to requests by shoppers for assistance. Thus, such details could include an indication of their current status, such as their current degree of availability and/or lack thereof. The storage of such a local copy of such information within the service device 300 may better enable the employee to access that information to make needed updates thereto.

The storage 360 may store one or both of capture data 334 and decoded data 335. Not unlike the capture data 134 of the shopping devices 100, the capture data 334 may be defined within the storage 360 as a buffer location in which data captured by the scanning engine 310, the manual controls 320, the microphone 372, and/or the example virtual manual control 382 depicted as being visually presented on the display 380. As such buffered data within the capture data 334 is processed to interpret its meaning (either by the processor(s) 350 of the service device 300 or by processor(s) of another device), indications of what has been decoded via such processing may be stored as part of the decoded data 335, not unlike the decoded data 135 of the shopping devices 100. For example, indications of touches of the display 380 that may be consistent with operation of any virtual manual controls 382 presented thereon may be buffered within the capture data 334, before being interpreted to identify what virtual manual control 382 may have been operated, whereupon indications of such operation of such virtual manual controls 382 may be stored within the decoded data 335. Also by way of example, images captured by the scanning engine 310 of what may be indicia for being decoded may be buffered within the capture data 334, before being processed to identify and decode any such indicia therein, whereupon indications of what may have been decoded therefrom may be stored within the decoded data 335. By way of a further example, audio captured by the microphone 372 of what may be an employee's voice input may be buffered within the capture data 334, before being processed to identify and decode any speech sounds that may be present, whereupon indications of words spoken that identify an item 820 of interest to a shopper that the employee is assisting, etc. may be stored within the decoded data 335.

The storage 360 may store presentation data 338, which may be defined within the storage 360 as a buffer of images presented on the display 380. Such buffered images may include, and is not limited to, images of items 820 about which assistance is being requested by a shopper and/or accompanying information, images of virtual manual controls 382, images of guides to a shopper requesting assistance that may be presented on the display 380 (e.g., arrows and/or indications of distance), etc.

The storage 360 may store a control routine 340 that may incorporate a sequence of instructions operative on the one or more processors 350 to cause the processor(s) 350 to perform various functions to support the work undertaken by an employee within the retail facility 940. Among those various functions may be to interact with various ones of the other components 305, 310, 320, 360, 372, 378, 380 and/or 390 to perform various operations. By way of example, the processor(s) 350 may operate various ones of the components 310, 320, 372, 378 and/or 380 to provide the aforedescribed UI. Also by way of example, the processor(s) 350 may operate at least the network interface 390 to exchange data with one or more other devices 100, 500 and/or 600 through one or more of the wireless links 994 of the network 999 formed with one or more of the WAPs 400. Further by way of example, the processor(s) 350 may operate at least the network interface 390 to cooperate with the at least some of the WAPs 400 and/or the support server(s) 500 to derive the current location of the service device 300 within the retail facility 940.

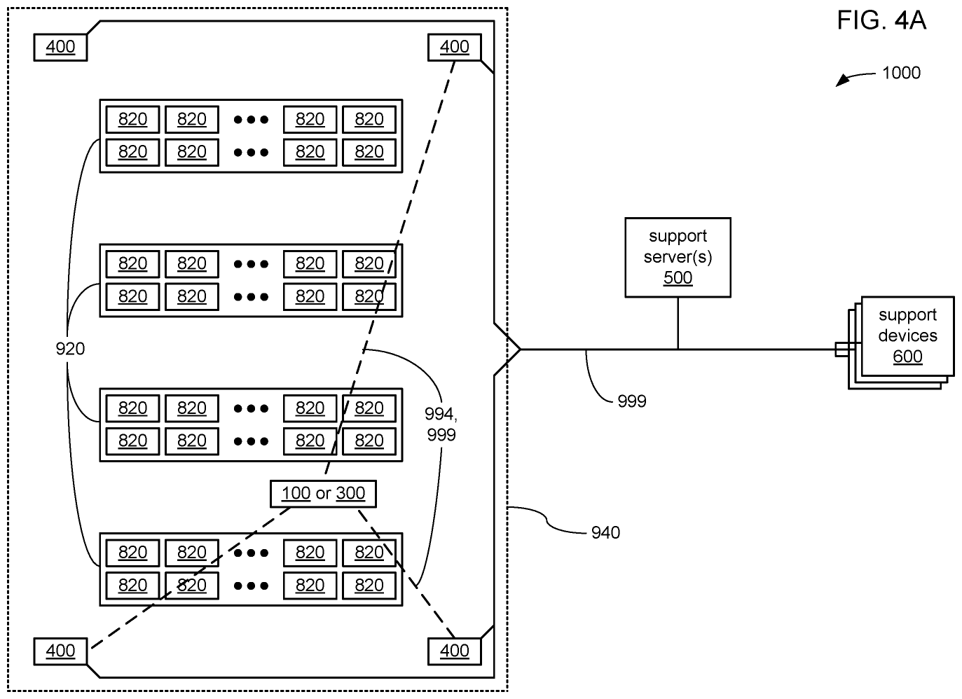

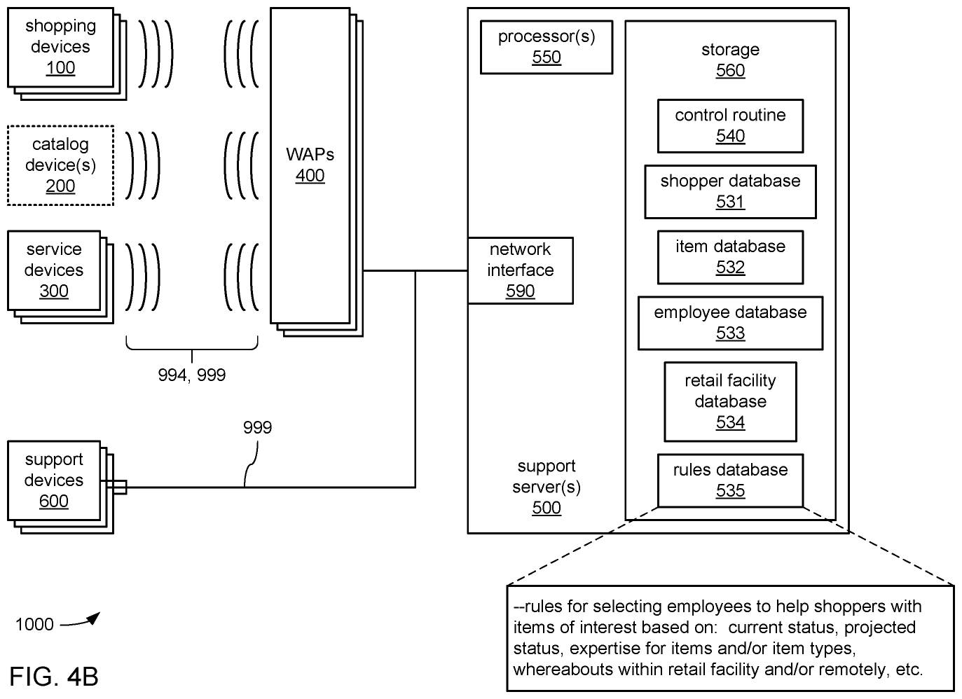

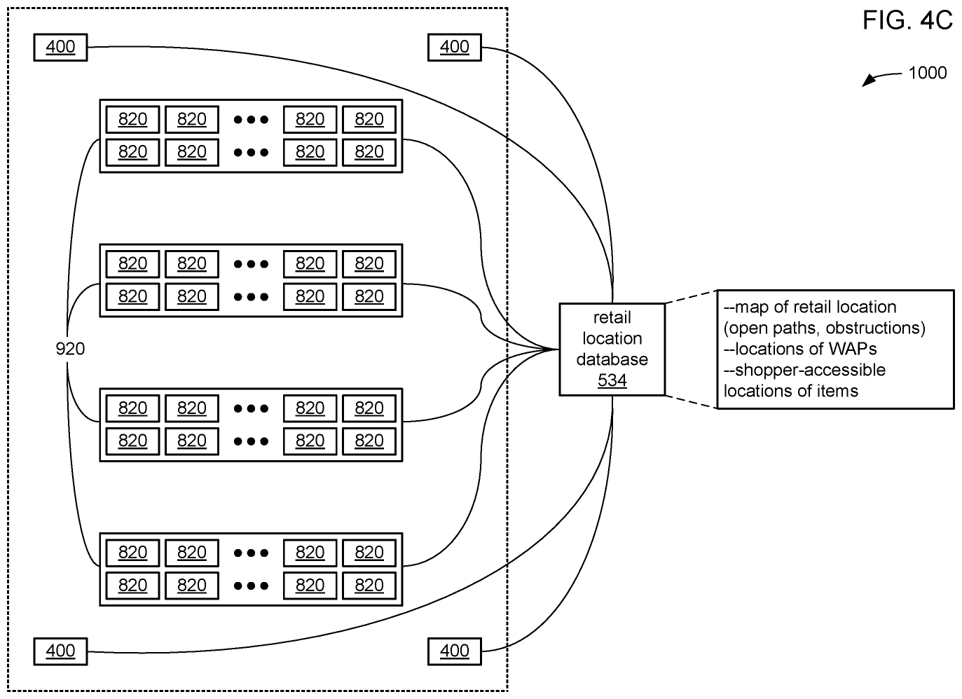

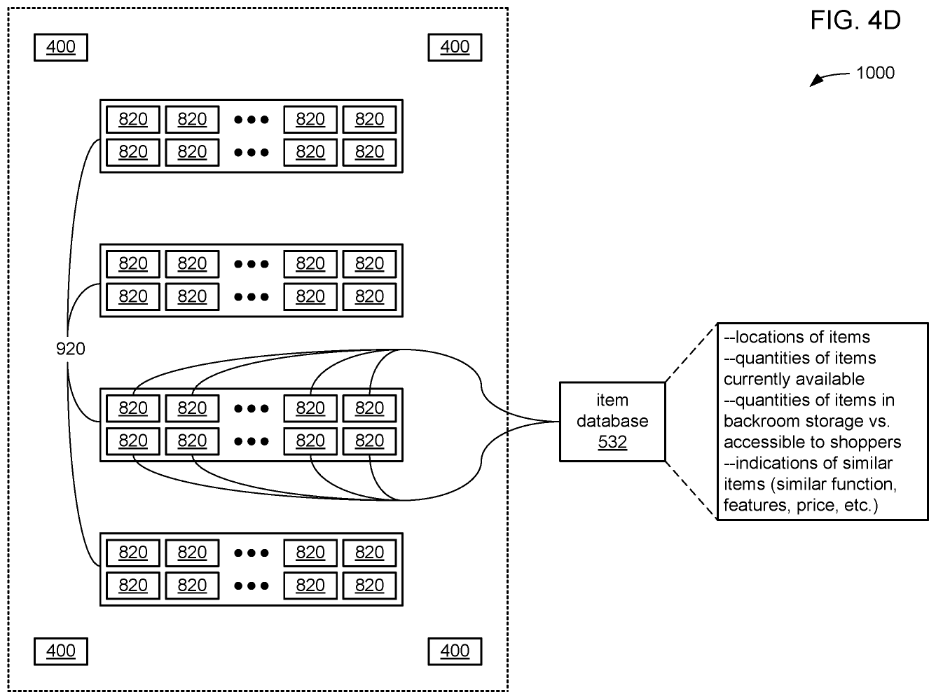

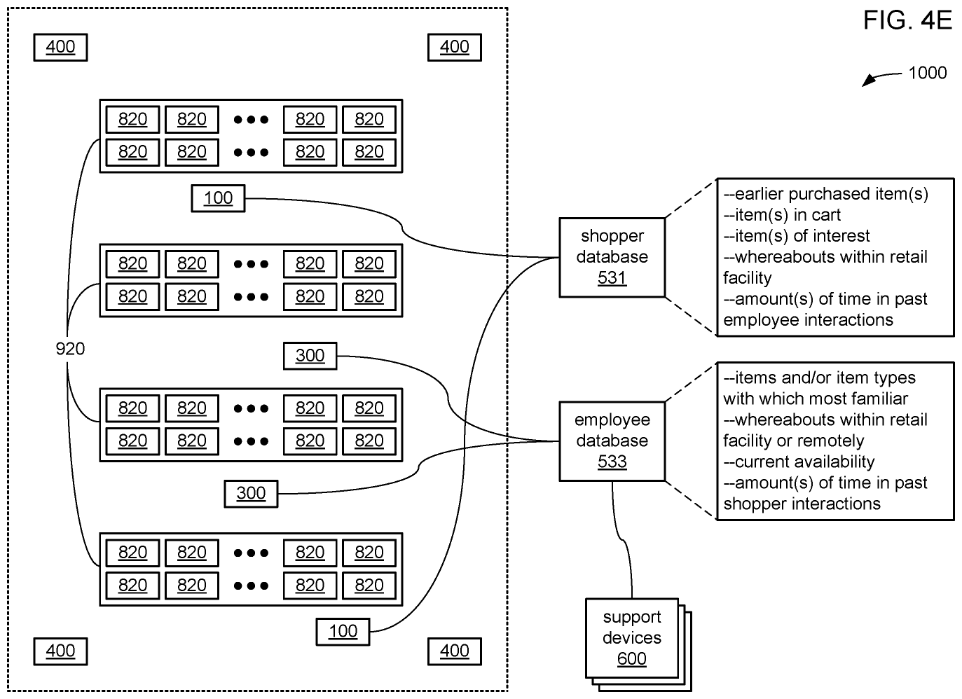

FIGS. 4A, 4B, 4C, 4D and 4E, together, depict aspects of the one or more support servers 500 of the shopping support system 1000 in greater detail.

FIG. 4A, depicts a deliberately highly simplified example layout of storage locations 920 and items 820 stored within the retail facility 940 in which a simple set of aisles are defined, and in which just four of the WAPs 400 are positioned at the corners. It should be noted that such a highly simplified layout of the interior of the retail facility 940 is shown solely for purposes of illustration, and to avoid the inclusion of unnecessary clutter. It is envisioned that an actual example of the retail facility 940 would include a far more complex layout, and would include a far greater quantity of WAPs 400.

As depicted in this deliberately highly simplified example, the one or more support servers 500 may be coupled to the depicted WAPs 400 and multiple support devices 600 via wired network connections of the network 999, while the depicted example shopping device 100 or service device 300 is coupled to the depicted WAPs 400 via multiple wireless links 994 of the network 999. As also depicted, such multiple wireless links 994 of the network 999 also enable the location of the depicted shopping device 100 or service device 300 within the retail facility 940 to be triangulated.

Turning to FIG. 4B, in addition to FIG. 4A, each one of the one or more support servers 500 may include one or more processors 550, a storage 560, and/or a network interface 590. These components 560 and/or 590 may each be communicatively coupled to the one or more processors 550 to exchange data therewith through the exchange of electrical, optical, magnetic and/or other signals through one or more buses and/or other form of interconnect.

The storage 560 may store a shopper database 531, an item database 532, an employee database 533, a retail facility database 534, and/or a rules database 535. The storage 560 may also store a control routine 540 that may incorporate a sequence of instructions operative on the one or more processors 550 to cause the processor(s) 550 to perform various functions, including functions to support shoppers shopping for items 820 of interest, and functions to support employees maintaining an inventory of items 820 and providing assistance to the shoppers when requested by the shoppers.

The rules database 535 may store specifications for various rules that may be employed by the processor(s) 550 of the one or more support server(s) 500 in performing various operations as part of supporting the shopping for items 820 of interest by shoppers and/or as part of supporting the work of employees. Among such stored rules may be one or more rules for selecting employees to assist shoppers with items 820 of interest. Among the factors that may be used in selecting employees may be the current status of each employee that may be selected, projections of when the status of such employees may change to being available when not currently available, degree of familiarity each employee may have for various items 820 and/or for various types of items, and/or current whereabouts of each employee within a retail facility in which there is a shopper requesting assistance. It should be noted that such rules for selecting an employee to assist a shopper may be different for different retail facilities 940, different types of items 820 offered for rental and/or sale, different corporate entities associated with retail facilities 940, different cultural customs, different countries, different regions within countries, etc.

Turning to FIG. 4C, the retail facility database 534 may incorporate one or more separate entries for each retail facility, including the example retail facility 940 depicted in FIGS. 4A and 4C-E. More specifically, for each such retail facility, the location database 534 may include a map of the retail facility that may detail open paths therein (e.g., open aisles), obstructions blocking such paths, the locations of WAPs 400 therein, where storage locations 920 are positioned that are accessible to shoppers, and/or where other storage locations 920 may be positioned that are not accessible to shoppers.

Turning to FIG. 4D, the item database 532 may incorporate a separate entry for each item 820 that is offered across one or more retail facilities, including the example retail facility 940 depicted in FIGS. 4A and 4C-E. More specifically, for each item 820 offered at the retail facility 940, the item database 532 may include indications of the quantity currently available thereat, the storage location(s) 920 at which they may currently be stored therein, the quantity(ies) currently stored at a shopper accessible storage location 920 versus at a storage location 920 that is not accessible to shoppers, and/or indications of other items that are deemed to be similar (e.g., similar by function, by features and/or by price) that are currently available thereat.

As the employees at a retail facility 940 store, update inventory and/or move about items 820 therein, their use of their service devices 300 to scan indicia carried by items 820 (or carried by boxes of the items 820) and indicia associated with storage locations 920 therein, indications of current quantities and/or current whereabouts of items 820 therein may be automatically updated within the item database 532.

Turning to FIG. 4E, the shopper database may incorporate a separate entry for each shopper that may have an account with a particular retail facility and/or with a corporate entity that is associated with multiple retail facilities (e.g., the example retail facility 940 depicted in FIGS. 4B-E). More specifically, for each shopper, the shopper database 531 may include indications of items 820 previously purchased, items 820 currently in a cart (e.g., in a virtual cart for online sale), item(s) 820 that are currently of interest and/or item(s) 820 that have previously been of interest, current whereabouts of the shopper within a retail facility 940, and/or amount(s) of time required of an employee in past interaction(s) therewith.

The employee database may similarly incorporate a separate entry for each employee that may be associated with a particular retail facility (e.g., the example retail facility 940 of FIGS. 4B-E) or across multiple retail facilities. Alternatively or additionally, the employee database may incorporate a separate entry for each employee at a remote location 960 (see FIG. 1). More specifically, for each employee, the employee database 533 may include indications of items 820 and/or types of items 820 with which the employee is most familiar (e.g., items 820 and/or types of items 820 for which the employee has been trained), current whereabouts of the employee within a retail facility 940 and/or at a remote location 960, current degree of availability of the employee (e.g., work schedule), and/or amount(s) of time required to assist shoppers in past interactions with shoppers.

Referring back to FIGS. 4A-E, in executing the control routine 540, processor(s) 550 of the one or more support servers 500 may be caused, through the network interface 590, to monitor the WAPs 400 within a retail facility 940 for indications received from shopping devices 100 of various events. Such events may include, and are not limited to, a shopping device 100 becoming associated with a particular shopper and/or ceasing to be associated with a particular shopper, a request from a shopper to be guided to a storage location 920 of an item 820 of interest, a request from a shopper for assistance from an employee with an item 820 of interest, and/or a request from a shopper for assistance from an employee in identifying an item 820 that may fit their needs (such that it may become an item 820 of interest). At least some of such indications of events may be accompanied by an identifier of the shopper and/or an identifier of the item 820 of interest.

In some embodiments, it may be that the receipt of such an indication of an event may cause the processor(s) 550 to respond by cooperating with the WAPs 400 and the shopping device 100 from which the indication is received to use triangulation to determine the current location of that shopping device 100, and thereby, the current location of the shopper associated with it (unless the current location of that shopping device 100 is already known). In other embodiments, it may be that the processor(s) 550 may be caused to operate the WAPs 400 within the retail facility 940 to recurringly use triangulation to recurringly determine the current whereabouts of each shopping device 100 therein that is currently associated with a shopper.

Also in executing the control routine 540, processor(s) 550 of the one or more support servers 500 may be caused, by execution of the control routine 540, to operate the WAPs 400 within a retail facility 940 to recurringly use triangulation to recurringly determine the current whereabouts of each service device 300 therein that is currently associated with an employee who is indicated in the employee database 533 as being currently available to assist shoppers. Processor(s) 550 of the one or more support servers 500 may also be caused, through the network interface 590, to monitor the WAPs 400 within the retail facility 940 for indications received from service devices 300 of various events. Such events may include, and are not limited to, a service device 300 becoming associated with a particular employee and/or ceasing to be associated with a particular employee, and/or a change in the current availability of an employee to assist shoppers. At least some of such indications of events may be accompanied by an identifier of the employee. Also, at least some of such indications of events may be accompanied by an identifier of an item 820 of interest to a shopper, if there is yet an item 820 of interest to that shopper and the employee associated with that service device 300 is currently engaged in assisting that shopper with that item 820.

Thus, as an employee designated in the employee database 533 as being one who is to assist shoppers arrives at a retail facility 940 and becomes available to assist shoppers, the processor(s) 550 may respond to receiving an indication of their availability from an service device 300 by updating the entry for that employee in the employee database 533 to reflect the fact that they are currently at the retail facility 940 and are currently available to assist shoppers. In a similar manner, the current availability of each employee may be updated in the employee database 533 as the availability of each employee changes throughout the time during which the retail facility 940 is open to shoppers.

As the employees move about and/or store items 820 within the retail facility 940, indications of such actions may be relayed by their service devices 300 to the one or more servers 500, and the processor(s) 550 thereof may respond by updating the information concerning those items 820 within the item database 532.

Also, as a shopper arrives at the retail facility 940 and is provided with a shopping device 100, the processor(s) 550 may respond to receiving an indication of their arrival and of becoming associated with that shopping device 100 by updating the entry for that shopper in the shopper database 531 to reflect the fact that they are currently at the retail facility 940. In a similar manner, as that shopper provides input to that shopping device 100 of an identity of an item 820 of interest and/or an indication of an item type that may lead to the identification of an item 820 of interest, such information about that shopper's activities may be updated in the shopper database 531.

As previously discussed, each shopping device 100 that is provided to a shopper may provide a UI to its associated shopper that enables that shopper to request to be guided to the current location of an item 820 of interest, to request assistance from an employee with an item 820 of interest, and/or to request assistance from an employee with identifying an item 820 of interest that may meet their needs. Such a UI may include one or more manual controls 120 and/or virtual manual controls 182, such as the depicted controls 120 and 182 in FIG. 2C labeled with the word “Help”. Such a UI may also include at least the ability to present a shopper with a description and/or instructions of how to use the UI to obtain the particular type of assistance they seek.

Where the request from a shopper is to be guided to the current location of a particular already known item 820 of interest within a retail facility 940, use of the UI of the shopping device 100 to make that request may cause processor(s) 150 thereof (as a result of executing the control routine 140 therein) to transmit an indication of the request via at least one wireless link 994 to at least one WAP 400, from which it may be relayed onward to the one or more support servers 500. Again, the request may include an indication of the identity of the item 820 of interest, if such information has not already been earlier provided to the one or more support servers 500 by the shopping device 100. In response to the receipt of that request, processor(s) 550 of the one or more support servers 500 may be caused (by execution of the control routine 540) to retrieve an indication from the item database 532 of where ones of the item 820 of interest may be found within the retail facility 940.

Presuming that there is at least one of the item 820 of interest within the retail facility 940 at a storage location 920 that is meant to be accessible to shoppers, the processor(s) 550 of the one or more support servers 500 may use indications of the current location of that shopping device 100 and of the item 820 of interest to derive a path for the shopper to be guided thereto. The processor(s) 550 may then be caused to cooperate with the processor(s) 150 of that shopping device 100 to provide such guidance (e.g., visually on the display 180 thereof, and/or audibly through the speaker 178 thereof) to the shopper. As such guidance is provided, and as the shopper presumably follows such guidance, the processor(s) 550 may be caused to cooperate with at least a subset of the WAPs 400 and with the processor(s) 150 of that shopping device 100 to monitor the movement of the shopper by recurringly deriving the current location of that shopping device 100, and recurringly updating the guidance that it provides to the shopper.

Where the request from a shopper is for assistance to be provided by an employee with a particular already known item 820 of interest, use of the UI of the shopping device 100 to make that request may cause processor(s) 150 thereof to transmit an indication of the request via at least one wireless link 994 to at least one WAP 400, from which it may be relayed onward to the one or more support servers 500. Again, the request may include an indication of the identity of the item 820 of interest, if such information has not already been earlier provided to the one or more support servers 500 by the shopping device 100. In response to the receipt of that request, processor(s) 550 of the one or more support servers 500 may be caused (by execution of the control routine 540) to retrieve indications from the employee database 533 of which employees associated with the retail facility 940 may have relatively greater familiarity with the item 820 of interest (or at least familiarity with items 820 of the same type), and/or which employees associated with the retail facility 940 are currently available. The processor(s) 550 may also retrieve one or more rules for selecting an employee to assist a shopper based on various factors from the rules database 535.

Presuming there are one or more employees available within the retail facility 940 to assist that shopper, the processor(s) 550 may initially use the retrieved rules to select one of those employees to be the one to assist the shopper. Depending on the rules, such a choice may be based on such factors as physical proximity to the shopper so that the shopper may be provided with assistance more quickly, and/or a degree of familiarity with the item 820 of interest to the shopper (or at least degree of familiarity with items 820 of the same type) that is greater than the degree of familiarity of other employees by at least a predetermined degree of difference (e.g., where degrees of familiarity are quantified and/or scaled). In some embodiments, where an employee is indicated in the employee database 533 as being particularly familiar with the item 820 of interest, but is currently indicated as being engaged in assisting another shopper, a prediction may be made of how much longer that employee will remain engaged with that other shopper based on stored information concerning past amount(s) of time required for that employee to assist other shoppers and/or stored information concerning past amount(s) of employee time utilized by that other shopper. Where such a prediction indicates that the employee is likely to become available within an amount of time that is less than a threshold maximum amount of time, then the shopper making the request for assistance may be given an indication through the UI of their shopping device 100 that an employee will be assisting them shortly.

Where the request from a shopper is for assistance to be provided by an employee with identifying an item 820 that may meet the needs of the shopper (such that it may become an item 820 of interest), use of the UI of the shopping device 100 to make that request may cause processor(s) 150 thereof to transmit an indication of the request via at least one wireless link 994 to at least one WAP 400, from which it may be relayed onward to the one or more support servers 500. Since the identity of the item 820 of interest is not yet known, the request may include an indication of there being a lack of an identity of an item 820 of interest, if such an indication has not already been earlier provided to the one or more support servers 500 by the shopping device 100. In response to the receipt of that request, processor(s) 550 of the one or more support servers 500 may be caused (by execution of the control routine 540) to cooperate with the shopping device 100 to use the UI to present one or more queries to the shopper to attempt to elicit one or more characteristics of type of item that the shopper is seeking. Presuming the shopper is able to provide one or more of such characteristics, the processor(s) 550 may use such characteristics in conjunction with indications in the employee database 533 of which employees associated with the retail facility 940 may have relatively greater familiarity with one or more types of items 820 that have such characteristics, as well as indications in the employee database 533 of which employees associated with the retail facility 940 are currently available. Again, the processor(s) 550 may also retrieve one or more rules for selecting an employee to assist a shopper based on various factors from the rules database 535. However, if the shopper is not able to provide such characteristics, then the processor(s) 550 may rely more heavily upon (or solely upon) one or more rules for selecting an employee to assist a shopper based more on location.

As previously discussed, each service device 300 may provide a UI to its associated employee that enables that employee to provide indications of their current availability and to be guided to the current location of a shopper to provide assistance thereto, when possible, with an item 820 of interest to that shopper. Such a UI may include one or more manual controls 320 and/or virtual manual controls 382, such as the depicted controls 320 and 382 in FIG. 3B labeled with the word “Busy”, by which that employee may provide an indication of their current availability. Presuming that an employee is available to assist the shopper requesting assistance, and presuming that employee is selected by the processor(s) 550 to provide such assistance, the processor(s) 350 of the service device 300 associated with that employee may be caused (by execution of the control routine 340) to use such a UI to provide that employee with an indication of there being a shopper in need of assistance, along with an indication of the item 820 of interest to that shopper (if the shopper is able to identify an item 820 of interest).

It should be noted that, among the rules retrieved from the rules database 535 may be a rule for determining whether assistance for a shopper should be provided with direct personal interaction or by remote communication based on at least such a factor as the current distance between a selected employee and the shopper. Thus, depending on such a factor, the processor(s) 550 may determine whether the selected employee should go to the current location of the shopper to assist them. If so, then the processor(s) 550 may be caused to use the current locations of the shopper and the employee to derive a path for the employee to be guided along to the shopper. The processor(s) 550 and 350 may then cooperate to provide the employee with guidance, via the UI of the service device 300, to the current location of the shopper. However, where the processor(s) 550 make the determination that the employee is to assist the shopper remotely through voice communications, then the processor(s) 550 may cooperate with the processor(s) 150 of the shopping device 100 and the processor(s) 350 of the service device 100 to establish voice communications therebetween through wireless links 994 and WAPs 400 at the retail facility 940.

However, if there are employees available at the retail facility 940 at which the shopper is requesting assistance, but none are indicated in the employee database 533 to have significantly more familiarity with the item 820 of interest (or the type of item that may be of interest, if known) to the shopper than the other available (or soon to be available) employees, then the processor(s) 550 of the one or more support servers 500 may be caused to operate the multiple WAPs 400 at the retail facility 940 to broadcast a request to the multiple service devices 300 associated with the multiple employees that are currently available for one them to assist the shopper. At each of those service devices 300, processor(s) 350 thereof may be caused, by execution of the control routine 340, to use the UI thereof to provide the associated one of the available employees with an indication of such a request for assistance, along with an indication of the item of interest to that shopper (or the type of item that may be of interest, if known). Such indications of the request may prompt one of those employees to provide an indication that they will assist the shopper via that UI, which may then be relayed onward to the one or more support servers 500. In response to the receipt of such a response by that one of those employees, the processor(s) 550 may transmit an indication to the service devices 300 of the others of those employees that the request for assistance by the shopper is now being addressed. The processor(s) 550 may then also determine (as previously discussed) whether the responding employee is to assist the shopper in person or remotely via voice communications.

However, if there are no employees available at the retail facility 940 to provide the assistance requested by the shopper, then the processor(s) 550 of the one or more support servers 500 may be caused, at least partially based on the retrieved rules, to at least attempt to select an available employee at a remote location 960. Depending on what is specified by the retrieved rules, such an attempted selection may be at least partially based on which one(s) of such remote employees may have more familiarity with the item 820 of interest to the shopper than others (or familiarity with the type of item that may be of interest, if known). If such an employee is able to be identified and is selected, then the processor(s) 550 may establish voice communications between the shopper and the selected remote employee through the shopping device 100 and the support device 600 (see FIG. 1) associated with the selected employee. Alternatively, if such a remote employee with such a degree of familiarity with the item 820 of interest (or familiarity with the type of item that may be of interest, if known) is not available, then the processor(s) 550 may broadcast a request for one remote employee of multiple available remote employees to remotely assist the shopper via such voice communications.

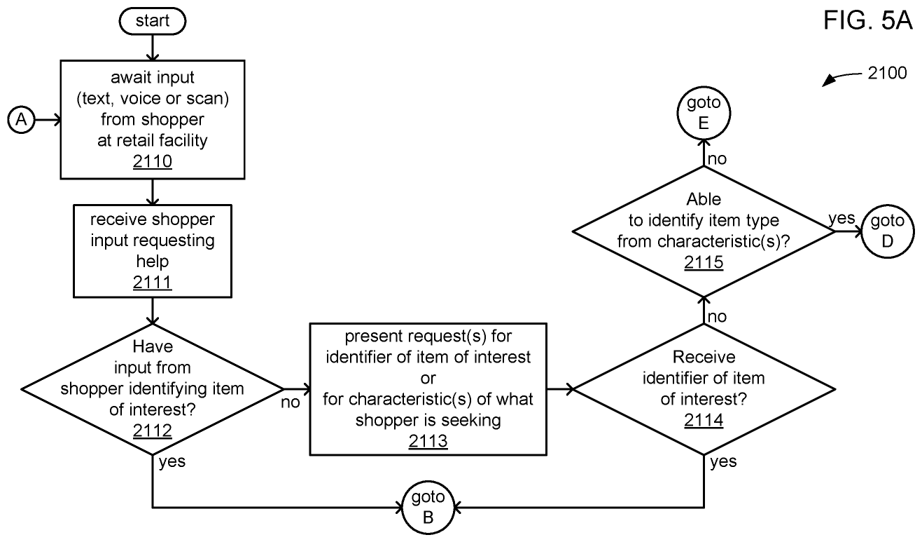

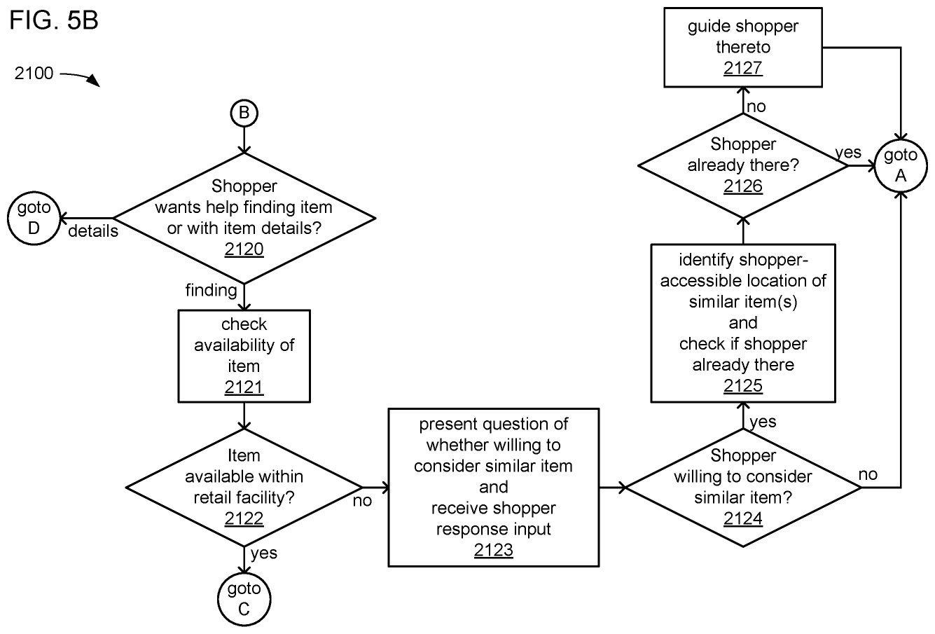

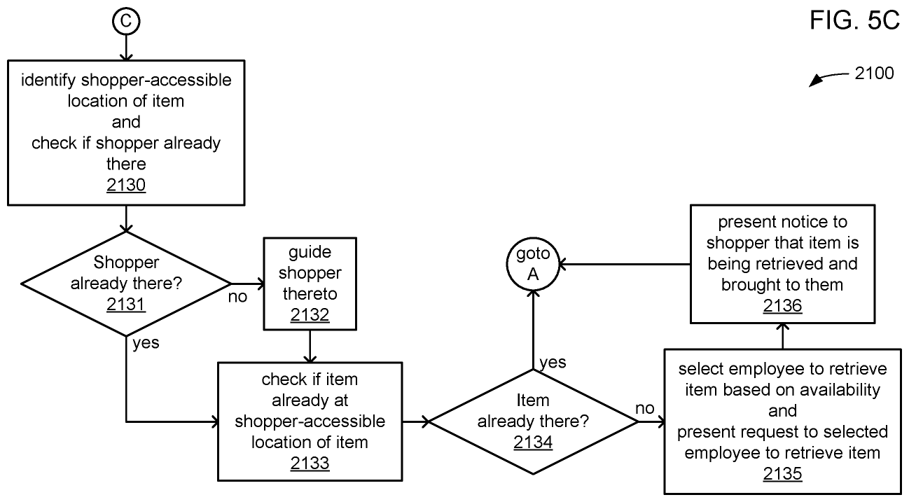

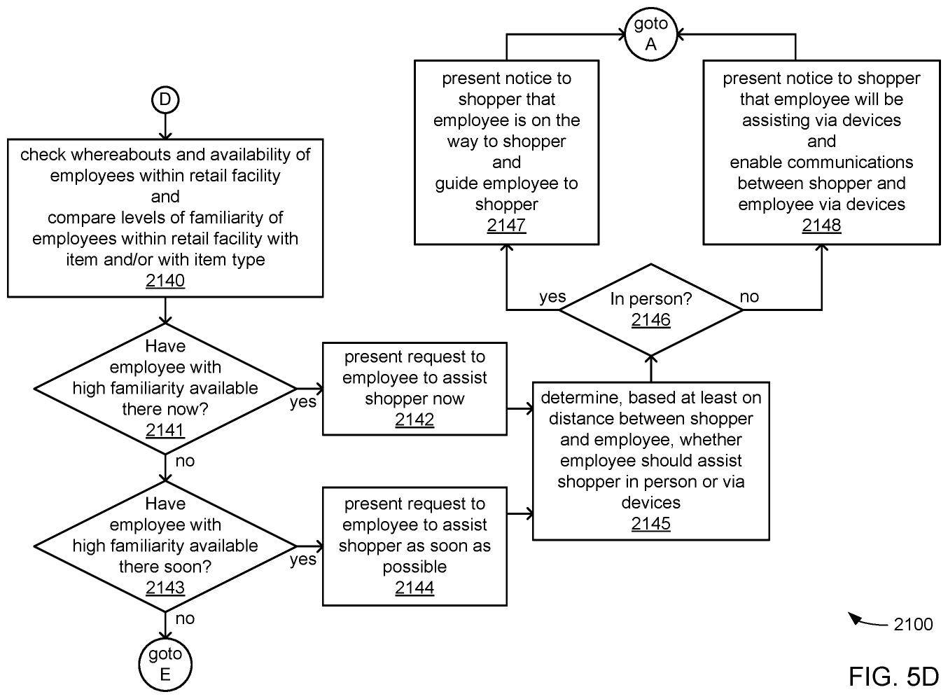

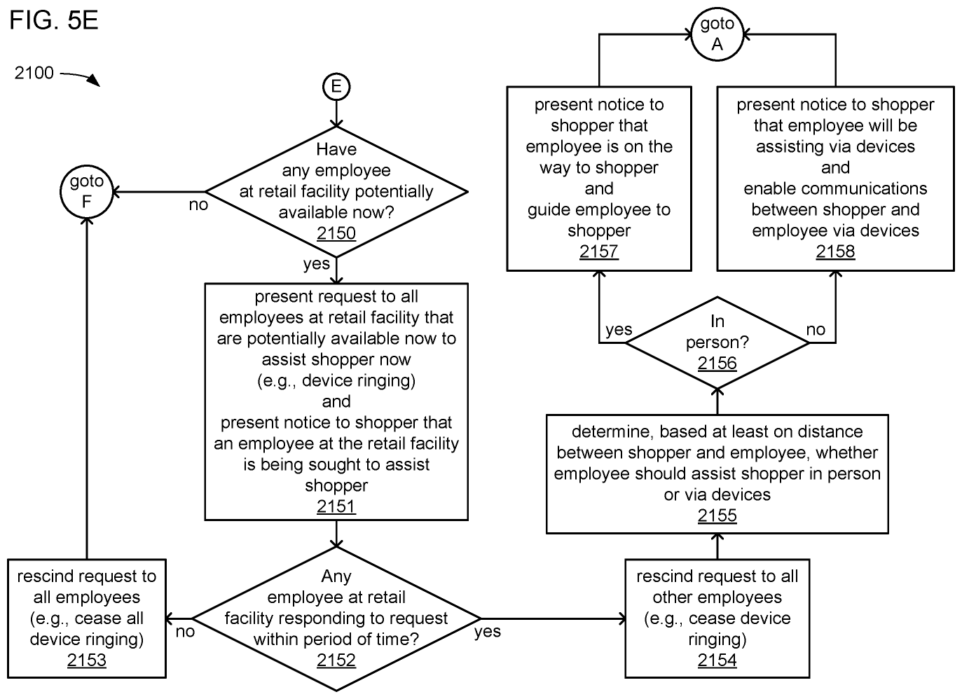

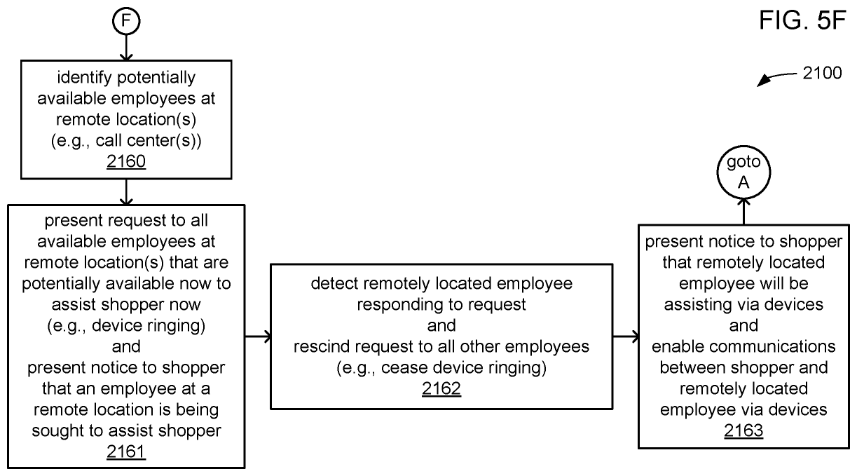

FIGS. 5A, 5B, 5C, 5D, 5E and 5F, together, provide a flowchart 2100 depicting aspects of operation of the shopping support system 1000 to address request(s) from a shopper to be guided to an item of interest and/or for assistance with an item of interest by an employee. More specifically, FIGS. 5A-E depict aspects of operations performed by one or more of the processors 150, 350 and/or 550 of one or more of a shopping device 100, one or more service devices 300 and/or one or more support servers 500, respectively.

Starting with FIG. 5A, at 2110, processor(s) of a shopping device associated with a shopper at a retail facility (e.g., processor(s) 150 of a shopping device 100 provided to a shopper at a retail facility 940) may be caused by a control routine to provide a user interface (UI) by which the shopper may provide input. At 2111, such input from the shopper may be received that includes a request from the shopper for help. At 2112, a check may be made as to whether the shopper has, either with the request for help or at an earlier time, provided input that identifies an item of interest (e.g., an item 820) to the shopper. If so, then at 2120 (see FIG. 5B), a check may be made of the type of assistance requested by the shopper. However, if not, then at 2113, the processor(s) of the shopping device may employ the UI to present the shopper with one or more requests for an identifier of an item of interest to the shopper, or for one or more characteristics for an item that the shopper may be seeking to fill a need of the shopper. At 2114, a check may be made as to whether an identifier of an item of interest has now been provided by the shopper. If so, then again at 2120 (see FIG. 5B), a check may be made of the type of assistance requested by the shopper. If not, then at 2115, a check may be made as to whether the one or more characteristics provided by the shopper are enough to enable at least a type of item to be identified. If an item type is able to be identified based on provided characteristic(s), then at 2140 (see FIG. 5D), a check may be made of the whereabouts and availability of employees. However, if an item type is not able to be identified based on provided characteristic(s), then at 2150 (see FIG. 5E), a check may be made as to whether there are any available employees at the retail facility.

It should be noted that, in some embodiments, the determination of whether the shopper is requesting assistance with identifying an item of interest to fit their needs may be based on whether the shopper provides an identifier of an item of interest. Of course, this is based on a presumption that, if the shopper had already identified an item of interest that they are seeking, then they would be able to provide an identifier of that item, and they would want to provide such an identifier to increase the speed and efficiency with which they could buy or rent that item of interest from the retail facility.

Turning to FIG. 5B, at 2120, a check may be made as to whether the request from the shopper at 2111 is for assistance in finding the item of interest or for assistance from an employee concerning other aspects of the item of interest, such as details of its manner of operation, features, etc. It should be noted that, in some embodiments, this determination may be made automatically by processor(s) of the shopping device and/or processor(s) of a support server (e.g., processor(s) 550 of a support server 500). Specifically, it may be that the current location of the shopper is compared to the known location(s) of one(s) of the item of interest. If the current location of the shopper (which may be based on the current location of the shopping device) is not near any such location of the item of interest, then the determination may be made that the request is for assistance in finding the item of interest within the retail facility. However, if the current location of the shopper is at such a location of the item of interest, then the determination may be that the request is for assistance from an employee with the item of interest (e.g., to ask the employee questions about the item of interest, to help move it, etc.).

If, at 2120, the request is for assistance with details of the item of interest (e.g., answering questions about the item of interest, helping with retrieving the item of interest from a shelf, etc.), then again at 2140 (see FIG. 5D), a check may be made of the whereabouts and availability of employees. However, if, at 2120, the request is for assistance in finding the item of interest, then at 2121, the processor(s) of a support server may be caused to check the availability of the item of interest at the retail facility. If, at 2122, the at least one of the item of interest is available at the retail facility, then at 2130 (see FIG. 5C), a shopper-accessible location of the item of interest may be identified. However, if, at 2122, the item of interest is not available at the retail facility, then at 2123, the processor(s) of the support server may transmit a request to the processor(s) of the shopping device to present the shopper with the question of whether the shopper is willing to consider another similar item. If, at 2124, the shopper provides input indicating that the shopper is not willing to consider a similar item, then the processor(s) of the shopping device may return to awaiting further input from the shopper at 2110 in FIG. 5A. However, if, at 2124, the shopper provides input indicating that the shopper is willing to consider a similar item, then at 2125, processor(s) of the support server may search through a database of items to identify a similar item and check whether that item is at the current location of the shopper. If, at 2126, the shopper is already at a shopper-accessible location of the similar item, then the processor(s) of the shopping device may return to awaiting further input from the shopper at 2110 in FIG. 5A. However, if, at 2126, the shopper is not already at that location, then at 2127, the processors of the shopping device and the support server may cooperate with multiple WAPs installed at the retail facility (e.g., the multiple WAPs 400 at the retail facility 940) to recurringly use triangulation and the UI of the shopping device to guide the shopper to that location, before returning to awaiting further input from the shopper at 2110 in FIG. 5A.

Turning to FIG. 5C, at 2130, processor(s) of the support server may be caused to identify a storage location of one of the item of interest that is meant to be accessible to shoppers, and check whether the shopper is already at that location. If, at 2131, the shopper is not already at that location, then at 2132, the processors of the shopping device and the support server may cooperate with the multiple WAPs installed at the retail facility to guide the shopper to that location. Regardless of whether the shopper is already at that location, or is guided there, at 2133, the processor(s) of the support server may check an entry in a database for the item of interest (e.g., the item database 532) to determine if at least one of that item is present at that location. If, at 2134, at least one of the item of interest is so present, then the processor(s) of the shopping device may return to awaiting further input from the shopper at 2110 in FIG. 5A. However, if, at 2134, none of the item if interest is at that location, then at 2135, processor(s) of the support server may select an employee to retrieve at least one of the item of interest from a storage location that is not accessible to shoppers, and may cooperate with processor(s) of that employee's service device to present a request to so retrieve at least one of the item of interest. Also, at 2136, the processor(s) of the support server may cooperate with processor(s) of the shopping device to present the shopper with an indication that the item of interest is being retrieved for them, before the processor(s) of the shopping device return to awaiting further input from the shopper at 2110 in FIG. 5A.

Turning to FIG. 5D, at 2140, processor(s) of the support server may check the availability and whereabouts of employees within the retail facility, and may also compare indications in the employee database of levels of familiarity of each of the available employees with the item of interest specified by the shopper or with the item type of what may become the item of interest to the shopper. If, at 2141, there is an employee having a relatively high degree of familiarity with the item of interest or with such an item type, and who is currently available, then at 2142, processor(s) of the support server may cooperate with processor(s) of a service device of that employee to present a request to that employee to assist the shopper. However, if at 2141, there is no such employee currently available, then at 2143, a check may be made as to whether there is an employee having a relatively high degree of familiarity with the item of interest or with such an item type, and who is predicted to be available within a period of time that is less than a maximum threshold of predicted time. If, at 2143, no such employee is predicted to be so available, then at 2150 (see FIG. 5E), a check may be made as to whether there are any available employees at the retail facility. However, if at 2143, there is such an employee who is predicted to be so available, then at 2144, the processor(s) of the support server may cooperate with processor(s) of a service device of that employee to present a request to that employee to assist the shopper as soon as possible. Regardless of whether an employee having a relatively high degree of familiarity with the item of interest or with such an item type is currently available and is contacted at 2142, or such an employee is predicted to soon be available and is contacted at 2144, at 2145 the processor(s) of the support server may make a determination of whether the selected employee is to assist the shopper in person, or remotely via voice communication through their service device and the shopping device of the shopper. If, at 2146, and based on at least the current distance between the shopper and the selected employee, the determination is to provide the requested assistance in person, then at 2147, the shopper is presented with an indication via the UI of the shopping device that an employee is on the way to the shopper, and the selected employee is provided with guidance via the UI of the service device to the current location of the shopper. However, if, at 2146, the determination is to provide the requested assistance remotely, then the shopper is presented with an indication that an employee will be contacting them through the shopping device, and the processor(s) of the support server are caused to establish voice communications between the shopper and the selected employee through the shopping device and the service device. Regardless of the exact manner in which the requested assistance is provided, following the provision of in person assistance at 2147 or the provision of remote assistance at 2148, the processor(s) of the shopping device may return to awaiting input from the shopper at 2110 in FIG. 5A.

Turning to FIG. 5E, at 2150, a determination may be made by processor(s) of the support server as to whether there area any employees at the retail facility, at all, who, as indicated in an employee database, are currently available (or at least are predicted to soon be available within the maximum threshold of predicted time). If not, then at 2160 (see FIG. 5F), potentially available employees at remote locations may be identified. However, if so, then at 2151, processor(s) of the support server may cooperate with processor(s) of each service device of each such currently available (and/or predicted to be available) employee at the retail facility to present a request to each for one of them to assist the shopper. Also at 2151, processor(s) of the support server may cooperate with processor(s) of the shopping device to present a notice to the shopper that an employee of the retail facility is being sought out to assist the shopper.

If, at 2152, none of the employees presented with the request at 2151 respond with an indication, within the predetermined period of time, that they will provide the requested assistance, then at 2153, the processor(s) of the support server may cooperate with the processors of the service devices of all of those employees to rescind the presentation of that request, before resorting to employees at remote location(s) at 2160 in FIG. 5F. However, if at 2152, any of those employees responds to that request with an indication that they will provide such assistance within a predetermined period of time, then at 2154, the processor(s) of the support server may cooperate with the processors of the service devices of all of the others of those employees to rescind the presentation of that request. At 2155 through 2158, and in a manner similar to 2145-2148 of FIG. 5D, a determination may be made as to whether to cause such assistance to be provided in person or remotely via voice communications, before returning to awaiting further input from the shopper at 2110 in FIG. 5A.

Turning to FIG. 5F, at 2160, processor(s) of the support server may refer to the employee database to determine which employee(s) at one or more remote locations are at least indicated as currently available (or are predicted to be available) at such remote location(s) (e.g., at one or more call centers). At 2161, the processor(s) of the support server may then cooperate with processor(s) of support devices associated with the one(s) of the remote employees who are at least so indicated as available to present each such employee with a request to provide the requested assistance to the shopper. Also, the processor(s) of the support server may cooperate with processor(s) of the shopping device of the shopper to present an indication to the shopper that an employee at a remote location is being sought to assist the shopper. At 2162, the processor(s) of the support server may receive an indication of one of those remotely located employees responding to that request with an indication that they will provide the requested assistance, and the processor(s) of the support server may responding by cooperating with the processors of the support devices of the other remote employees who were also presented with that request to rescind those presentations of that request. At 2163, the processor(s) of the support server may cooperate with the processor(s) of the shopping device to present the shopper with an indication that a remotely located employee will be assisting the shopper via communication through the shopping device and a device of that remotely located employee. Also, the processor(s) of the support server may establish voice communications therebetween, and following such communications, the processor(s) of the shopping device may return to awaiting further input from the shopper at 2110 in FIG. 5A.

There is thus disclosed a system and method for locating and summoning assistance with items offered for rental and/or for sale within a retail facility.

A shopping support system includes a set of wireless access points (WAPs) installed at a retail facility. A shopping support system also includes a shopping device including: a scanning engine to capture an image of an indicia that encodes an identifier of an item of interest to a shopper; a display to provide a user interface (UI) that enables the shopper to provide input indicative of at least one of at least one characteristic of the item, the identifier of the item, and a request for assistance; and a wireless network interface to cooperate with the set of WAPs to triangulate a current location of the shopping device within the retail facility, and to transmit, to at least one WAP of the set of WAPs, an indication of the input to the shopping device. A shopping support system further includes a server coupled to the set of WAPs, the server including at least one processor configured to: receive, from the at least one WAP, an indication of the current location of the shopping device, and the indication of the input provided to the shopping device; and in response to the input to the shopping device including the request for assistance, and based on other contents of the input to the shopping device, determine whether the request for assistance includes a first request for assistance in identifying the item based on the at least one characteristic, a second request for assistance associated with the item, or a third request for assistance in locating the item within the retail facility.

Determining, based on the other contents of the input to the shopping device, whether the request for assistance includes the first request, the second request or the third request may include the at least one processor performing operations including: determine whether the other contents include the at least one characteristic; and in response to the other contents including the at least one characteristic, determine that the request includes the first request, and perform operations including identify an item type of the item based on the at least one characteristic, and attempt to identify an employee at the retail facility to assist the shopper with the item based on at least one of availability of the employee and degree of familiarity of the employee with the item type.

In response to success in identifying an employee at the retail facility, the at least one processor may be further configured to: based on a distance between the employee and the current location of the shopping device within the retail facility, determine whether to direct the employee to go to the shopper within the retail facility, or to use a service device associated with the employee to communicate with the shopper through the service device and the shopping device about the item; and in response to a determination to direct the employee to go to the shopper, transmit an indication to the service device to cooperate with the set of WAPs to guide the employee to the current location of shopping device.

Determining, based on the other contents of the input to the shopping device, whether the request for assistance includes the first request, the second request or the third request may include the at least one processor performing operations including: determine whether the other contents include the identifier of the item; in response to the other contents including the identifier of the item, compare the current location of the shopping device to a shopper-accessible location of the item to determine whether the shopper is currently at the shopper-accessible location of the item; and in response to a determination that the shopper is currently at the shopper-accessible location of the item, determine that the request includes the second request, and attempt to identify an employee at the retail facility to assist the shopper with the item based on at least one of availability of the employee and degree of familiarity of the employee with the item.

Attempting to identify an employee at the retail facility to assist the shopper based on at least availability of the employee and degree of familiarity of the employee with the item may include the at least one processor performing operations including: identifying a set of available employees at the retail facility; comparing relative degrees of familiarity of each employee in the set with at least one of the item or a type of the item; and selecting the employee from among the set based at least on a relative degree of familiarity being greater than another relative degree of familiarity of another employee of the set by at least a predetermined threshold.

In response to being unable to identify an available employee at the retail facility with a degree of familiarity greater than another relative degree of familiarity of another employee of the set by at least the predetermined threshold, the at least one processor may be further configured to: transmit an additional request to assist the shopper to a set of service devices associated with the set of available employees; await receipt of an indication of one employee of the set of available employees responding to the additional request; and in response to receiving the indication of the response, transmit, to other service devices of the set of service devices, an indication of rescinding the additional request.

Determining, based on the other contents of the input to the shopping device, whether the request for assistance includes the first request, the second request or the third request may include the at least one processor performing operations including: determine whether the other contents include the identifier of the item; in response to the other contents including the identifier of the item, compare the current location of the shopping device to a shopper-accessible location of the item to determine whether the shopper is currently at the shopper-accessible location of the item; in response to a determination that the shopper is not currently at the shopper-accessible location of the item, determine that the request includes the third request, and determine whether the item is available within the retail facility; and in response to a determination that the item is available within the retail facility, transmit an indication to the shopping device to cooperate with the set of WAPs to guide the shopper to the shopper-accessible location of the item.

In response to the determination that the item is available within the retail facility, the at least one processor may be further configured to: determine whether the item is available at the shopper-accessible location of the item; and in response to determining that the item is not available at the shopper-accessible location of the item, perform operations including identify, based on availability, an employee a the retail facility to retrieve the item from a location within the retail facility that is not accessible to the shopper, transmit an indication to a service device associated with the employee to retrieve the item, and transmit an indication to the shopping device to present to the shopper, via the UI, that the item is being retrieved for the shopper.

In response to a determination that the item is not available within the retail facility, the at least one processor may be further configured to: transmit, to the shopping device, and for presentation to the shopper via the UI, an indication that the item is not available within the retail facility, and a request for an indication of whether the shopper is willing to consider a similar item as a substitute; in response to receiving an indication from the shopping device that the shopper is willing to consider a similar item, identify another item that is available within the retail facility and that is similar to the item based on at least a function performed by the item; and transmit an indication to the shopping device to cooperate with the set of WAPs to guide the shopper to a shopper-accessible location of the other item.

A method includes receiving, by at least one processor at a server of a shopping support system, and from a shopping device through at least one wireless access point (WAP) of a set of WAPs installed at a retail facility, an indication of input to the shopping device through a user interface (UI) that enables a shopper to provide input indicative of at least one of: at least one characteristic of the item; the identifier of the item; and a request for assistance. The method also includes receiving, by the at least one processor, and from the at least one WAP, an indication of a current location of the shopping device within the retail facility. The method further includes, in response to the input to the shopping device including the request for assistance, and based on other contents of the input to the shopping device, determining, by the at least one processor, whether the request for assistance includes: a first request for assistance in identifying the item based on the at least one characteristic; a second request for assistance associated with the item; or a third request for assistance in locating the item within the retail facility.

Determining, based on the other contents of the input to the shopping device, whether the request for assistance includes the first request, the second request or the third request may include performing operations including: determining, by the at least one processor, whether the other contents include the at least one characteristic; and in response to the other contents including the at least one characteristic, determining that the request includes the first request, and performing operations including identifying, by the at least one processor, an item type of the item based on the at least one characteristic, and attempting to identify, by the at least one processor, an employee at the retail facility to assist the shopper with the item based on at least one of availability of the employee and degree of familiarity of the employee with the item type.

Determining, based on the other contents of the input to the shopping device, whether the request for assistance includes the first request, the second request or the third request may include performing operations including: determining, by the at least one processor, whether the other contents include the identifier of the item; in response to the other contents including the identifier of the item, comparing, by the at least one processor, the current location of the shopping device to a shopper-accessible location of the item to determine, by the at least one processor whether the shopper is currently at the shopper-accessible location of the item; and in response to a determination that the shopper is currently at the shopper-accessible location of the item, determining, by the at least one processor, that the request includes the second request, and attempting to identify, by the at least one processor, an employee at the retail facility to assist the shopper with the item based on at least one of availability of the employee and degree of familiarity of the employee with the item.

Attempting to identify an employee at the retail facility to assist the shopper based on at least availability of the employee and degree of familiarity of the employee with the item may include performing operations including: identifying, by the at least one processor, a set of available employees at the retail facility; comparing, by the at least one processor, relative degrees of familiarity of each employee in the set with at least one of the item or a type of the item; and selecting, by the at least one processor, the employee from among the set based at least on a relative degree of familiarity being greater than another relative degree of familiarity of another employee of the set by at least a predetermined threshold.

The method may further include, in response to being unable to identify an available employee at the retail facility with a degree of familiarity greater than another relative degree of familiarity of another employee of the set by at least the predetermined threshold, performing operations including: transmitting an additional request to assist the shopper to a set of service devices associated with the set of available employees; awaiting receipt of an indication of one employee of the set of available employees responding to the additional request; and in response to receiving the indication of the response, transmitting, to other service devices of the set of service devices, an indication of rescinding the additional request.

Determining, based on the other contents of the input to the shopping device, whether the request for assistance includes the first request, the second request or the third request may include performing operations including: determining, by the at least one processor, whether the other contents include the identifier of the item; in response to the other contents including the identifier of the item, comparing, by the at least one processor, the current location of the shopping device to a shopper-accessible location of the item to determine whether the shopper is currently at the shopper-accessible location of the item; in response to a determination that the shopper is not currently at the shopper-accessible location of the item, determining, by the at least one processor, that the request includes the third request, and determining, by the at least one processor, whether the item is available within the retail facility; and in response to a determination that the item is available within the retail facility, transmitting an indication to the shopping device to cooperate with the set of WAPs to guide the shopper to the shopper-accessible location of the item.

The method may further include, in response to the determination that the item is available within the retail facility, performing operations including: determining, by the at least one processor, whether the item is available at the shopper-accessible location of the item; and in response to determining that the item is not available at the shopper-accessible location of the item, performing operations including identifying, by the at least one processor, based on availability, an employee a the retail facility to retrieve the item from a location within the retail facility that is not accessible to the shopper, transmitting an indication to a service device associated with the employee to retrieve the item, and transmitting an indication to the shopping device to present to the shopper, via the UI, that the item is being retrieved for the shopper.

The method may further include, in response to a determination that the item is not available within the retail facility, performing operations including: transmitting, to the shopping device, and for presentation to the shopper via the UI, an indication that the item is not available within the retail facility, and a request for an indication of whether the shopper is willing to consider a similar item as a substitute; in response to receiving an indication from the shopping device that the shopper is willing to consider a similar item, identifying, by the at least one processor, another item that is available within the retail facility and that is similar to the item based on at least a function performed by the item; and transmitting an indication to the shopping device to cooperate with the set of WAPs to guide the shopper to a shopper-accessible location of the other item.

A shopping device of a shopping support system includes: a scanning engine configured to capture an image of an indicia that encodes an identifier of an item of interest to a shopper; and a wireless network interface configured to cooperate with the set of WAPs to triangulate a current location of the shopping device within the retail facility, and to transmit, to at least one WAP of the set of WAPs, an indication of the input to the shopping device. The shopping device also includes at least one processor coupled to the scanning engine and the wireless network interface, and configured to: provide a user interface (UI) that enables the shopper to provide input indicative of at least one of at least one characteristic of the item, the identifier of the item, and a request for assistance; operate the wireless network interface to cooperate with the set of WAPs to triangulate a current location of the shopping device within the retail facility; operate the wireless network interface to transmit, to a support server via at least one WAP of the set of WAPs, an indication of the input to the shopping device; receive a transmission from the support server in response to the indication of the input to the shopping device, wherein, based on other contents of the input to the shopping device, the support server is configured to determine whether the request for assistance includes a first request for assistance in identifying the item based on the at least one characteristic, a second request for assistance associated with the item, or a third request for assistance in locating the item within the retail facility; in response to the received transmission including an indication that assistance from an employee will be provided in response to a determination by the support server that the request transmitted to the support server includes either the first request or the second request, present the indication that the assistance from an employee will be provided to the shopper via the UI; and in response to the received transmission including an indication of guidance to a shopper-accessible location associated with the item transmitted to the shopping device in response to a determination by the support server that the request transmitted to the support server includes the third request, present the guidance to the shopper via the UI, and cooperate with the set of WAPs to recurringly determine a current location of the shopping device within the retail facility.

The shopping device may further include a touch-sensitive display configured to provide a portion of the UI that includes a visual presentation of a virtual manual control, wherein a touch of the display at a location coincident with the virtual manual control provides the input to cause the at least one processor to generate and transmit the request for assistance to the support server.

The shopping device may further include a manual control, wherein operation of the manual control provides the input to cause the at least one processor to generate and transmit the request for assistance to the support server.

Various other components may be included and called upon for providing for aspects of the teachings herein. For example, additional materials, combinations of materials, and/or omission of materials may be used to provide for added embodiments that are within the scope of the teachings herein.

Standards for performance, selection of materials, functionality, and other discretionary aspects are to be determined by a user, designer, manufacturer, or other similarly interested party. Any standards expressed herein are merely illustrative and are not limiting of the teachings herein.

When introducing elements of the present disclosure or the embodiment(s) thereof, the articles “a,” “an,” and “the” are intended to mean that there are one or more of the elements. Similarly, the adjective “another,” when used to introduce an element, is intended to mean one or more elements. The terms “including” and “having” are intended to be inclusive such that there may be additional elements other than the listed elements.

While the disclosure has been described with reference to illustrative embodiments, it will be understood by those skilled in the art that various changes may be made and equivalents may be substituted for elements thereof without departing from the scope of the invention. In addition, many modifications will be appreciated by those skilled in the art to adapt a particular instrument, situation or material to the teachings of the invention without departing from the essential scope thereof. Therefore, it is intended that the claimed invention not be limited to the particular embodiment disclosed as the best mode contemplated for carrying out this invention, but that the invention will include all embodiments falling within the scope of the appended claims.

1. A shopping support system comprising:
a set of wireless access points (WAPs) installed at a retail facility;
a shopping device comprising:
a scanning engine to capture an image of an indicia that encodes an identifier of an item of interest to a shopper;
a display to provide a user interface (UI) that enables the shopper to provide input indicative of at least one of:
at least one characteristic of the item;
the identifier of the item; and
a request for assistance; and
a wireless network interface to cooperate with the set of WAPs to triangulate a current location of the shopping device within the retail facility, and to transmit, to at least one WAP of the set of WAPs, an indication of the input to the shopping device; and
a server coupled to the set of WAPs, the server comprising at least one processor configured to:
receive, from the at least one WAP, an indication of the current location of the shopping device, and the indication of the input provided to the shopping device; and
in response to the input to the shopping device comprising the request for assistance, and based on other contents of the input to the shopping device, determine whether the request for assistance comprises:
a first request for assistance in identifying the item based on the at least one characteristic;
a second request for assistance associated with the item; or
a third request for assistance in locating the item within the retail facility.

2. The shopping support system of claim 1, wherein determining, based on the other contents of the input to the shopping device, whether the request for assistance comprises the first request, the second request or the third request comprises the at least one processor performing operations comprising:
determine whether the other contents comprise the at least one characteristic; and
in response to the other contents comprising the at least one characteristic, determine that the request comprises the first request, and perform operations comprising:
identify an item type of the item based on the at least one characteristic; and
attempt to identify an employee at the retail facility to assist the shopper with the item based on at least one of availability of the employee and degree of familiarity of the employee with the item type.

3. The shopping support system of claim 2, wherein, in response to success in identifying an employee at the retail facility, the at least one processor is further configured to:
based on a distance between the employee and the current location of the shopping device within the retail facility, determine whether to direct the employee to go to the shopper within the retail facility, or to use a service device associated with the employee to communicate with the shopper through the service device and the shopping device about the item; and
in response to a determination to direct the employee to go to the shopper, transmit an indication to the service device to cooperate with the set of WAPs to guide the employee to the current location of shopping device.

4. The shopping support system of claim 1, wherein determining, based on the other contents of the input to the shopping device, whether the request for assistance comprises the first request, the second request or the third request comprises the at least one processor performing operations comprising:
determine whether the other contents comprise the identifier of the item;
in response to the other contents comprising the identifier of the item, compare the current location of the shopping device to a shopper-accessible location of the item to determine whether the shopper is currently at the shopper-accessible location of the item; and
in response to a determination that the shopper is currently at the shopper-accessible location of the item, determine that the request comprises the second request, and attempt to identify an employee at the retail facility to assist the shopper with the item based on at least one of availability of the employee and degree of familiarity of the employee with the item.

5. The shopping support system of claim 4, wherein, attempting to identify an employee at the retail facility to assist the shopper based on at least availability of the employee and degree of familiarity of the employee with the item comprises the at least one processor performing operations comprising:
identifying a set of available employees at the retail facility;
comparing relative degrees of familiarity of each employee in the set with at least one of the item or a type of the item; and
selecting the employee from among the set based at least on a relative degree of familiarity being greater than another relative degree of familiarity of another employee of the set by at least a predetermined threshold.

6. The shopping support system of claim 4, wherein, in response to being unable to identify an available employee at the retail facility with a degree of familiarity greater than another relative degree of familiarity of another employee of the set by at least the predetermined threshold, the at least one processor is further configured to:
transmit an additional request to assist the shopper to a set of service devices associated with the set of available employees;
await receipt of an indication of one employee of the set of available employees responding to the additional request; and
in response to receiving the indication of the response, transmit, to other service devices of the set of service devices, an indication of rescinding the additional request.

7. The shopping support system of claim 1, wherein determining, based on the other contents of the input to the shopping device, whether the request for assistance comprises the first request, the second request or the third request comprises the at least one processor performing operations comprising:
determine whether the other contents comprise the identifier of the item;
in response to the other contents comprising the identifier of the item, compare the current location of the shopping device to a shopper-accessible location of the item to determine whether the shopper is currently at the shopper-accessible location of the item;
in response to a determination that the shopper is not currently at the shopper-accessible location of the item, determine that the request comprises the third request, and determine whether the item is available within the retail facility; and
in response to a determination that the item is available within the retail facility, transmit an indication to the shopping device to cooperate with the set of WAPs to guide the shopper to the shopper-accessible location of the item.

8. The shopping support system of claim 7, wherein, in response to the determination that the item is available within the retail facility, the at least one processor is further configured to:
determine whether the item is available at the shopper-accessible location of the item; and
in response to determining that the item is not available at the shopper-accessible location of the item, perform operations comprising:
identify, based on availability, an employee a the retail facility to retrieve the item from a location within the retail facility that is not accessible to the shopper;
transmit an indication to a service device associated with the employee to retrieve the item; and
transmit an indication to the shopping device to present to the shopper, via the UI, that the item is being retrieved for the shopper.

9. The shopping support system of claim 7, wherein, in response to a determination that the item is not available within the retail facility, the at least one processor is further configured to:
transmit, to the shopping device, and for presentation to the shopper via the UI, an indication that the item is not available within the retail facility, and a request for an indication of whether the shopper is willing to consider a similar item as a substitute;
in response to receiving an indication from the shopping device that the shopper is willing to consider a similar item, identify another item that is available within the retail facility and that is similar to the item based on at least a function performed by the item; and
transmit an indication to the shopping device to cooperate with the set of WAPs to guide the shopper to a shopper-accessible location of the other item.

10. A method comprising:
receiving, by at least one processor at a server of a shopping support system, and from a shopping device through at least one wireless access point (WAP) of a set of WAPs installed at a retail facility, an indication of input to the shopping device through a user interface (UI) that enables a shopper to provide input indicative of at least one of:
at least one characteristic of the item;
the identifier of the item; and
a request for assistance;
receiving, by the at least one processor, and from the at least one WAP, an indication of a current location of the shopping device within the retail facility; and
in response to the input to the shopping device comprising the request for assistance, and based on other contents of the input to the shopping device, determining, by the at least one processor, whether the request for assistance comprises:
a first request for assistance in identifying the item based on the at least one characteristic;
a second request for assistance associated with the item; or
a third request for assistance in locating the item within the retail facility.

11. The method of claim 10, wherein determining, based on the other contents of the input to the shopping device, whether the request for assistance comprises the first request, the second request or the third request comprises performing operations comprising:
determining, by the at least one processor, whether the other contents comprise the at least one characteristic; and
in response to the other contents comprising the at least one characteristic, determining that the request comprises the first request, and performing operations comprising:
identifying, by the at least one processor, an item type of the item based on the at least one characteristic; and
attempting to identify, by the at least one processor, an employee at the retail facility to assist the shopper with the item based on at least one of availability of the employee and degree of familiarity of the employee with the item type.

12. The method of claim 10, wherein determining, based on the other contents of the input to the shopping device, whether the request for assistance comprises the first request, the second request or the third request comprises performing operations comprising:
determining, by the at least one processor, whether the other contents comprise the identifier of the item;
in response to the other contents comprising the identifier of the item, comparing, by the at least one processor, the current location of the shopping device to a shopper-accessible location of the item to determine, by the at least one processor whether the shopper is currently at the shopper-accessible location of the item; and
in response to a determination that the shopper is currently at the shopper-accessible location of the item, determining, by the at least one processor, that the request comprises the second request, and attempting to identify, by the at least one processor, an employee at the retail facility to assist the shopper with the item based on at least one of availability of the employee and degree of familiarity of the employee with the item.

13. The method of claim 12, wherein, attempting to identify an employee at the retail facility to assist the shopper based on at least availability of the employee and degree of familiarity of the employee with the item comprises performing operations comprising:
identifying, by the at least one processor, a set of available employees at the retail facility;
comparing, by the at least one processor, relative degrees of familiarity of each employee in the set with at least one of the item or a type of the item; and
selecting, by the at least one processor, the employee from among the set based at least on a relative degree of familiarity being greater than another relative degree of familiarity of another employee of the set by at least a predetermined threshold.

14. The method of claim 12, further comprising, in response to being unable to identify an available employee at the retail facility with a degree of familiarity greater than another relative degree of familiarity of another employee of the set by at least the predetermined threshold, performing operations comprising:
transmitting an additional request to assist the shopper to a set of service devices associated with the set of available employees;
awaiting receipt of an indication of one employee of the set of available employees responding to the additional request; and
in response to receiving the indication of the response, transmitting, to other service devices of the set of service devices, an indication of rescinding the additional request.

15. The method of claim 10, wherein determining, based on the other contents of the input to the shopping device, whether the request for assistance comprises the first request, the second request or the third request comprises performing operations comprising:
determining, by the at least one processor, whether the other contents comprise the identifier of the item;
in response to the other contents comprising the identifier of the item, comparing, by the at least one processor, the current location of the shopping device to a shopper-accessible location of the item to determine whether the shopper is currently at the shopper-accessible location of the item;
in response to a determination that the shopper is not currently at the shopper-accessible location of the item, determining, by the at least one processor, that the request comprises the third request, and determining, by the at least one processor, whether the item is available within the retail facility; and
in response to a determination that the item is available within the retail facility, transmitting an indication to the shopping device to cooperate with the set of WAPs to guide the shopper to the shopper-accessible location of the item.

16. The method of claim 15, further comprising, in response to the determination that the item is available within the retail facility, performing operations comprising:
determining, by the at least one processor, whether the item is available at the shopper-accessible location of the item; and
in response to determining that the item is not available at the shopper-accessible location of the item, performing operations comprising:
identifying, by the at least one processor, based on availability, an employee a the retail facility to retrieve the item from a location within the retail facility that is not accessible to the shopper;
transmitting an indication to a service device associated with the employee to retrieve the item; and
transmitting an indication to the shopping device to present to the shopper, via the UI, that the item is being retrieved for the shopper.

17. A shopping device of a shopping support system, the shopping device comprising:
a scanning engine configured to capture an image of an indicia that encodes an identifier of an item of interest to a shopper;
a wireless network interface configured to cooperate with the set of WAPs to triangulate a current location of the shopping device within the retail facility, and to transmit, to at least one WAP of the set of WAPs, an indication of the input to the shopping device; and
at least one processor coupled to the scanning engine and the wireless network interface, the at least one processor configured to:
provide a user interface (UI) that enables the shopper to provide input indicative of at least one of:
at least one characteristic of the item;
the identifier of the item; and
a request for assistance;
operate the wireless network interface to cooperate with the set of WAPs to triangulate a current location of the shopping device within the retail facility;
operate the wireless network interface to transmit, to a support server via at least one WAP of the set of WAPs, an indication of the input to the shopping device;
receive a transmission from the support server in response to the indication of the input to the shopping device, wherein, based on other contents of the input to the shopping device, the support server is configured to determine whether the request for assistance comprises:
a first request for assistance in identifying the item based on the at least one characteristic;
a second request for assistance associated with the item; or
a third request for assistance in locating the item within the retail facility.

18. The shopping device of claim 17,
wherein in response to the received transmission comprising an indication that assistance from an employee will be provided in response to a determination by the support server that the request transmitted to the support server comprises either the first request or the second request, present the indication that the assistance from an employee will be provided to the shopper via the UI; and
wherein in response to the received transmission comprising an indication of guidance to a shopper-accessible location associated with the item transmitted to the shopping device in response to a determination by the support server that the request transmitted to the support server comprises the third request, present the guidance to the shopper via the UI, and cooperate with the set of WAPs to recurringly determine a current location of the shopping device within the retail facility.

19. The shopping device of claim 17, further comprising a touch-sensitive display configured to provide a portion of the UI that includes a visual presentation of a virtual manual control, wherein a touch of the display at a location coincident with the virtual manual control provides the input to cause the at least one processor to generate and transmit the request for assistance to the support server.

20. The shopping device of claim 17, further comprising a manual control, wherein operation of the manual control provides the input to cause the at least one processor to generate and transmit the request for assistance to the support server.
